(19) United States
(12) Patent Application Publication
(10) Pub. No.: US 2010/0257953 A1
(43) Pub. Date: Oct. 14, 2010

(54) DOUBLE CLUTCH TRANSMISSION

(75) Inventors: Wolfgang RIEGER, Friedrichshafen (DE); Matthias REISCH, Ravensburg (DE); Juergen WAFZIG, Eriskirch (DE); Gerhard GUMPOLTSBERGER, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/758,977

(22) Filed: Apr. 13, 2010

(30) Foreign Application Priority Data
Apr. 14, 2009 (DE) 10 2009 002 352.6

(51) Int. Cl. F16H 3/08

(52) U.S. Cl. 74/329

(57) ABSTRACT

A double clutch transmission with two clutches whose input sides are connected to a drive shaft and whose output sides are each connected to one of two transmission input shafts positioned coaxial with respect to one another. At least two countershafts provided and support toothed idler gearwheels while the two transmission input shafts support toothed fixed gearwheels such that it is possible to shift at least a plurality of power shift forward gears and/or at least one reverse gear. Five gear planes are provided so that at least one winding path gear is shiftable when at least one coupling device, assigned to the output gear, is disengaged.

This application claims priority from German patent application serial no. 10 2009 002 352.6 filed Apr. 14, 2009.

### FIELD OF THE INVENTION

The present invention relates to a double clutch transmission.

### BACKGROUND OF THE INVENTION

A six-speed or seven-speed double clutch transmission is known from published patent DE 103 05 241 A1. The double clutch transmission comprises two clutches, each of which is connected on its input side to the drive shaft and on its output side to one of the two transmission input shafts. The two transmission input shafts are placed coaxially relative to each other. Furthermore, two countershafts are situated axially parallel to the two transmission input shafts, with their idler gears engaging the fixed gears of the transmission input shafts. Moreover, coupling devices are held on the countershafts so that they are axially movable and rotationally fixed, in order to be able to shift the respective toothed gearwheels. The chosen transmission ratio is transmitted to a differential through the output gears. In order to realize the desired transmission ratio stages with the known double clutch transmission, a large number of gear planes are necessary, so that the construction space required for installation is not insignificant.

Furthermore, a spur-gear multi-speed transmission is known from published patent DE 38 22 330 A1. The spur-gear multi-speed transmission comprises a double clutch which is shiftable under load, one part of which is connected to a driveshaft, and the other part of which is connected to a hollow driveshaft that is rotatably supported on the driveshaft. For certain transmission ratios, the driveshaft can be coupled with the hollow driveshaft by means of a shift element.

From published patent DE 10 2004 001 961 A1 a power-shift transmission with two clutches is known, each of which is assigned to a subtransmission. The transmission input shafts of the two subtransmissions are placed coaxially to each other, and are engaged with idler gears of the countershafts via assigned fixed gears. The respective idler gears of the countershafts can be connected in a rotationally fixed manner with the respective countershaft by means of assigned shift elements. From this published patent an eight-speed transmission is known, in which an additional shift element is provided for coupling the two transmission input shafts to realize an additional transmission ratio stage. Even the seven-speed transmission in this form requires at least six gear planes in the two subtransmissions, in order to be able to realize the transmission ratio stages. This results in an undesirable lengthening of the construction length in the axial direction, so that the possibility of installation in a vehicle is significantly limited.

Furthermore, from published patent DE 10 2005 028 532 A1 an additional power-shift transmission is known, which includes two input shafts and only one countershaft. For example, an eight-speed transmission in this form requires more than seven gear planes in order to be able to realize the transmission ratio stages, including in particular the reverse gear transmission ratios. This results in an undesirable lengthening of the construction length in the axial direction.

### SUMMARY OF THE INVENTION

The object of the present invention is to propose a double clutch transmission of the species described at the beginning, wherein a plurality of power-shiftable transmission ratio stages are realized as economically as possible and with the fewest possible parts while requiring little construction space.

Accordingly, a construction-space-optimized double clutch transmission with two clutches is proposed, whose input sides are connected to a drive shaft, and whose output sides are each connected to one of two transmission input shafts which are situated coaxially to each other. The double clutch transmission comprises at least two countershafts, on which toothed gearwheels designed as idler gears are rotatably carried, there being toothed gearwheels designed as fixed gears, at least some of which are engaged with the idler gears, supported in a rotationally fixed manner on the two transmission input shafts. Also provided are a plurality of coupling devices for connecting an idler gear to a countershaft in a rotationally fixed manner. The double clutch transmission according to the invention has an output gear or constant pinion on each of the countershafts, each of which is coupled with gearing of a drive shaft in order to connect the respective countershaft with the output drive, making a plurality of power-shiftable gears feasible.

According to the invention, the proposed double clutch transmission preferably comprises only five gear planes, with which at least seven power-shiftable gears are realized with little construction space required. For example, one way in which the maximum of five gear planes can be formed is by at least two dual gear planes, wherein in each dual gear plane one idler gear of the first and second countershafts each is assigned to a fixed gear of one of the transmission input shafts and at least one idler gear is used for at least two gear speeds, so that at least one winding path gear is shiftable when there is at least one coupling device that is assigned to one of the output gears and is disengaged.

It is also possible to use single gear planes besides the dual gear planes, where in each single gear plane an idler gear of the countershafts is assigned to a fixed gear of one of the transmission input shafts. Other configurations are also possible.

Because of the possible multiple uses of idler gears, it is possible with the proposed double clutch transmission to realize a maximum number of gear ratios with the fewest possible gear planes, with the first seven forward gears preferably being power-shiftable with sequential design.

To optimize the stepping in the double clutch transmission proposed according to the invention, it is also possible for example to replace a dual gear plane with two single gear planes, by replacing one fixed gear with two fixed gears. That makes it possible to achieve especially harmonic, progressive gear stepping. It is also possible to replace two single gear planes with one dual gear plane.

The proposed double clutch transmission can preferably be designed as an 8-speed transmission with at least seven power-shiftable gear steps. Because of the short construction compared to known transmission arrangements, the double clutch transmission according to the invention is especially suited for a front transverse design in a vehicle. Other types of configurations are also possible, however, depending on the type and construction space situation of the particular vehicle in question.

Preferably, in the proposed double clutch transmission the first and/or eighth forward gears can be winding path gears. In addition, a reverse gear and/or other gears, for example crawler gears or overdrive gears, can also be designed as winding-path gears, and may possibly also be power-shiftable. For example, the first power-shiftable forward gear and the highest gear may be winding-path gears. Besides the two coupling devices provided as winding path gear shift elements on the constant pinions, additional shift elements can also be placed on the first and/or on the second countershaft to realize additional winding path gears. Thus both constant pinions are connected with the assigned countershaft in a shiftable manner. Preferably, only five gear planes will be realized in the proposed double clutch transmission, with at least two dual gear planes and at least two single gear planes being used.

For example, depending on the design, it is possible for four shiftable idler gears to be assigned to the first countershaft, each of them engaging with fixed gears of the assigned transmission input shafts. On the second countershaft, preferably three or four shiftable idler gears can be realized, each of which meshes with fixed gears of the assigned transmission input shaft.

If the last or next-to-last gear step is shifted higher than the one before it, especially high output torque or drive power can be made available when a downshift is requested by the driver.

Advantageously, in the double clutch transmission according to the invention a maximum of five shift points are needed on a countershaft. In total, however, a maximum of nine shift points on the two countershafts together can be sufficient to realize the proposed gear steps. Additional shift points are also possible.

According to the invention, provision can be made for the idler gear of the second subtransmission to be connected with the idler gear of the first subtransmission via the at least one additional shift element on the first and/or second countershaft, so that at least one winding path gear can be shifted by means of the shift element.

With the double clutch transmission according to the invention it is thus possible, with the coupling devices on the output gears disengaged, by means of the at least one switch element, to realize winding path gears, in which toothed gearwheels of both subtransmissions are coupled with each other in order to thereby realize a flow of power through both subtransmissions. The particular shift element utilized serves in this case to couple two idler gears, and thereby brings the transmission input shafts into dependency on each other.

In the double clutch transmission, the arrangement of the shift elements for coupling two particular idler gears can be varied so that the shift elements do not necessarily have to be placed between the idler gears that are to be coupled. Accordingly, other arrangement positions of the particular shift element are also conceivable, in order for example to optimize linking to an actuator system.

In the double clutch transmission it is possible according to one embodiment for two dual gear planes and three single gear planes to be provided, there being a first gear plane, a second gear plane and a third gear plane assigned to the fixed gears of the second transmission input shaft of the second subtransmission, each of them as a single gear plane, and there being a fourth gear plane and a fifth gear plane assigned to the fixed gears of the first transmission input shaft, each of them as a dual gear plane.

In another embodiment of the invention, it is also possible for three dual gear planes and two single gear planes to be provided in the proposed double clutch transmission. For example, a first gear plane as a dual gear plane, a second gear plane as a single gear plane and a third gear plane as a single gear plane can be assigned to the fixed gears of the second transmission input shaft of the second subtransmission, and a fourth gear plane and a fifth gear plane can be assigned to the fixed gears of the first transmission input shaft of the first subtransmission, each of them as a dual gear plane.

Alternatively, a first gear plane and a second gear plane as single gear planes can also be assigned to the fixed gears of the second transmission input shaft of the second subtransmission, each of them as a dual gear plane, and a third gear plane and a fourth gear plane can be assigned to the fixed gears of the first transmission input shaft of the first subtransmission, each of them as a single gear plane, as well as a fifth gear plane as a dual gear plane.

In order to provide the necessary reversal of rotation to realize reverse gears in the double clutch transmission according to the invention, it is possible to use at least one intermediate gear or the like, which is situated for example on an intermediate shaft. It is also possible for one of the idler gears of a countershaft to serve as the intermediate gear wheel for at least one reverse gear. No additional intermediate shaft is then necessary for the reverse gear, since one of the idler gears meshes both with a fixed gear and with another shiftable idler gear of the other countershaft. Thus the necessary intermediate gear wheel for the reverse gear is positioned on a countershaft as a shiftable idler gear, and also serves to realize at least one additional forward gear. The intermediate gear can also be designed as a stepped gear, independent of whether it is placed on the countershaft or on an additional intermediate shaft. It is also possible for the intermediate gear to not be placed on one of the already existing countershafts, but to be provided on another separate shaft, for example a third countershaft.

In order to obtain the desired transmission ratio steps, the double clutch transmission according to the invention may also include the provision that at least one bidirectionally operative coupling device or the like is situated on each countershaft. The provided coupling devices can each connect an assigned idler gear with the countershaft in a rotationally fixed manner in the activated or engaged state, depending on the direction of operation. In addition, a unidirectionally operating coupling device or the like can also be provided on at least one of the countershafts. The coupling devices used can be for example hydraulically, pneumatically, electrically or mechanically operated clutches, or also form locking claw clutches, as well as any type of synchronization device that provides a rotationally fixed connection between an idler gear and a countershaft. It is possible for a bidirectionally operative coupling device to be replaced by two unidirectionally operative coupling devices, or vice versa.

It is conceivable that the indicated positioning options for the toothed gearwheels may be varied, and also that the number of toothed gearwheels and the number of coupling devices may be changed, in order to realize still additional power-shiftable or non-power-shiftable gears, as well as to save construction space and parts in the proposed double clutch transmission. In particular, fixed gears of dual gear planes can be divided into two fixed gears for two single gear planes. That makes it possible to improve step changes. In addition, it is possible to exchange the countershafts. It is also possible for the subtransmissions to be exchanged i.e., to be mirrored around a vertical axis. In doing so, the hollow shaft and solid shaft are exchanged. This makes it possible to place the smallest gearwheel on the solid shaft, in order to further optimize utilization of the available construction space. In addition, neighboring gear planes can be exchanged, for example, to optimize shaft flexing and/or to link a shift actuating system optimally. Moreover, the particular placement position of the coupling devices at the gear plane can be varied. Furthermore, the direction of action of the coupling devices can also be changed.

The gear numberings used here were defined freely. It is also possible to add a crawler or creeper gear and/or an overdrive or fast gear, in order to improve the off-road properties or the acceleration behavior of a vehicle. Furthermore, it is possible to omit a first gear, for example, in order to better optimize the step changes overall. The gear numbering varies logically when these measures are used.

Independent of the particular variant embodiments of the double clutch transmission, the drive shaft and the output shaft may preferably also not be situated coaxially to each other; this realizes an especially space-saving arrangement. For example, the shafts, which are thus positioned spatially one behind the other, may also be offset slightly relative to each other. With this arrangement, a direct gear with a transmission ratio of one is realizable by means of tooth engagement, and can be advantageously shifted to the sixth through ninth gears relatively freely. Other possible arrangements of the drive shaft and output shaft are also conceivable.

Preferably, the proposed double clutch transmission is equipped with an integrated output stage. The output stage can include, as the output gear, a fixed gear on the output shaft, which meshes both with a first output gear as a shiftable constant pinion of the first countershaft and also with a second output gear as a shiftable constant pinion of the second countershaft. Thus both output gears are designed as shiftable gearwheels. To shift the particular output gear, a coupling device may be assigned, which in its disengaged state releases the connection between the assigned countershaft and the output gear, in order to shift winding path gears.

Advantageously, the lower forward gears and the reverse gears can be actuated via a start-up clutch or shifting clutch, in order to thereby concentrate higher loads on this clutch so that the second clutch can be designed for smaller construction space and at lower cost. In particular, the gear planes in the proposed double clutch transmission can be situated so that the vehicle can be set in motion either by means of the inner transmission input shaft or the outer transmission input shaft, and thus by means of whichever clutch is better suited in the particular case; this is also possible with a concentrically arranged, radially nested construction of the double clutch. To that end, the gear planes may be correspondingly arranged mirror-symmetrically, or may be exchanged.

Independent of the particular variant embodiment, in the double clutch transmission the provided gear planes for example may be exchanged.

### BRIEF DESCRIPTION OF THE DRAWINGS

The present invention will be explained in greater detail below on the basis of the drawing. The figures show the following:

FIG. 1 a schematic view of a 1st variant embodiment of an eight-speed double clutch transmission according to the invention;

FIG. 2 a shift pattern of the 1st variant embodiment according to FIG. 1;

FIG. 3 a schematic view of a 2nd variant embodiment of the eight-speed double clutch transmission according to the invention;

FIG. 4 a shift pattern of the 2nd variant embodiment according to FIG. 3;

FIG. 5 a schematic view of a 3rd variant embodiment of the eight-speed double clutch transmission according to the invention;

FIG. 6 a shift pattern of the 3rd variant embodiment according to FIG. 5;

FIG. 7 a schematic view of a 4th variant embodiment of the eight-speed double clutch transmission according to the invention;

FIG. 8 a shift pattern of the 4th variant embodiment according to FIG. 7;

FIG. 9 a schematic view of a 5th variant embodiment of the eight-speed double clutch transmission according to the invention;

FIG. 10 a shift pattern of the 5th variant embodiment according to FIG. 9;

FIG. 11 a schematic view of a 6th variant embodiment of the eight-speed double clutch transmission according to the invention;

FIG. 12 a shift pattern of the 6th variant embodiment according to FIG. 11;

FIG. 13 a schematic view of a 7th variant embodiment of the eight-speed double clutch transmission according to the invention; and

FIG. 14 a shift pattern of the 7th variant embodiment according to FIG. 13.

### DETAILED DESCRIPTION OF THE PREFERRED EMBODIMENTS

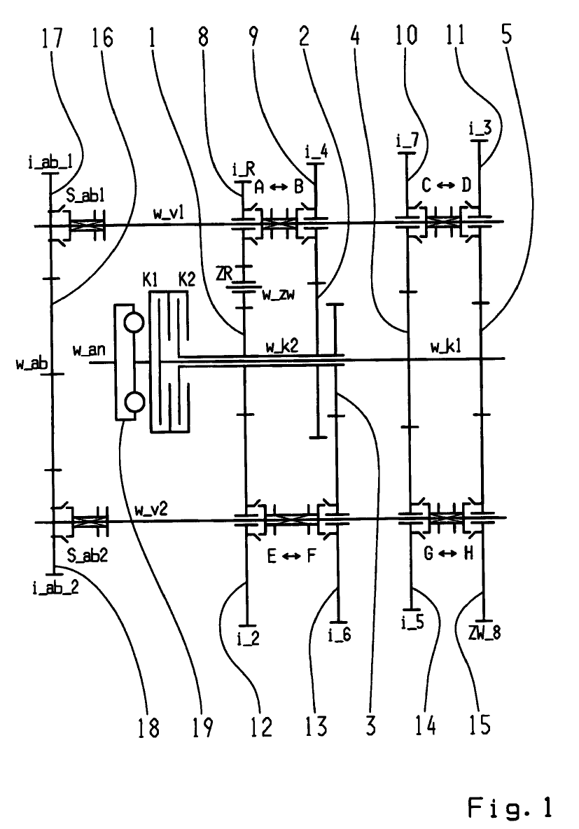

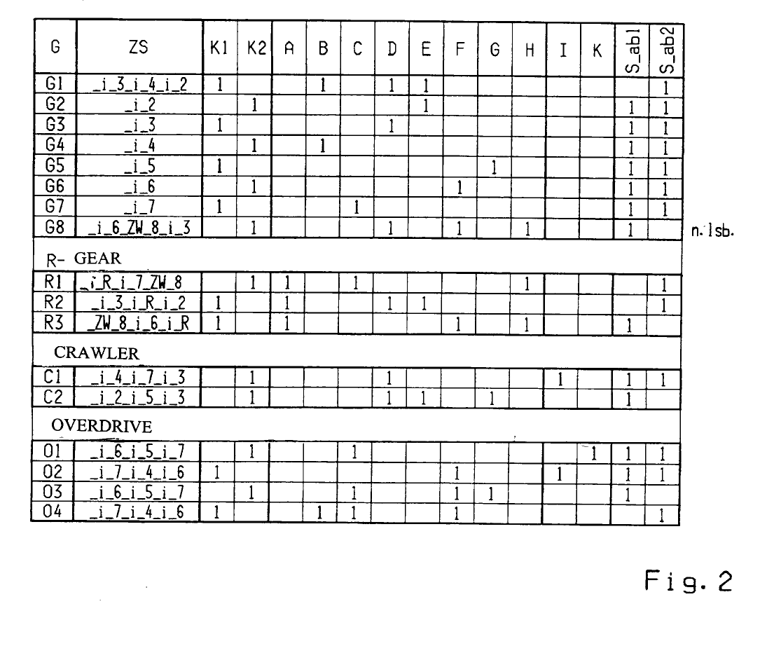

FIGS. 1, 3, 5, 7, 9, 11 and 13 each show a possible variant embodiment of an eight-speed double clutch transmission. The respective shift patterns for the different variant embodiments are depicted in tabular form in FIGS. 2, 4, 6, 8, 10, 12 and 14.

The eight-speed double clutch transmission comprises two clutches K1, K2, whose input sides are connected to a driveshaft w_an and whose output sides are each respectively connected to one of two transmission input shafts w_k1, w_k2 which are positioned coaxially to each other. In addition, a torsion vibration damper 19 can be placed on the driveshaft w_an. Furthermore, two countershafts w_v1, w_v2 are provided, on which toothed gear wheels in the form of idler gears 8, 9, 10, 11, 12, 13, 14, 15 are rotatably supported. Placed on the two transmission input shafts w_k1, w_k2 are rotationally fixed toothed gearwheels in the form of fixed gears 1, 2, 3, 4, 5 at least some of which are meshed with the idler gears 8, 9, 10, 11, 12, 13, 14, 15.

In order to be able to connect the idler gears 8, 9, 10, 11, 12, 13, 14, 15 with the respective countershaft w_v1, w_v2, a plurality of activatable coupling devices A, B, C, D, E, F, G, H are provided on the countershafts w_v1, w_v2. Furthermore, situated on the two countershafts w_v1, w_v2 as constant pinions are output gears 17, 18 each of which couples gearing of a fixed gear 16 of an output shaft w_ab, with corresponding output stages i_ab_1, i_ab_2 assigned to the output gears 17, 18.

Besides coupling devices A, B, C, D, E, F, G, H which in the activated state realize a rotationally fixed connection between a toothed gearwheel and the assigned countershaft w_v1, w_v2, on each of first and second countershafts w_v1, w_v2 a winding path gear coupling device S_ab1, S_ab2 is assigned to output stage i_ab1, i_ab2. When coupling device S_ab1 or S_ab2 is disengaged, the rotationally fixed connection between the output gear 17 or 18 and the first countershaft w_v1 or second countershaft w_v2 can be released. In the double clutch transmission it is possible if necessary to provide at least one winding path gear shift element I or K to connect two toothed gearwheels of a countershaft w_v1, w_v2 in a rotationally fixed manner, so that at least one winding path gear may also be realized through the activated shift elements I, K.

According to the invention, only five gear planes 8-1, 8-12, 9-2, 9-13, 3-13, 10-3, 10-14, 4-14, 11-15 are provided in the double clutch transmission, there being at least two dual gear planes 8-12, 9-13, 10-14, 11-15 provided in each variant embodiment, so that winding path gears are shiftable at least when coupling devices S_ab1 and S_ab2 are disengaged, and additionally if necessary by means of at least one of the activated shift elements I, K. A claw or the like may be used as the shift elements I, K for connecting two gearwheels or the like.

Shift element K, if present, is positioned on second countershaft w_v2, in order to connect idler gear 13 with idler gear 14 when shift element K is activated. Shift element I, if present, is provided on first countershaft w_v1, in order to connect idler gear 9 with idler gear 10 when shift element I is activated.

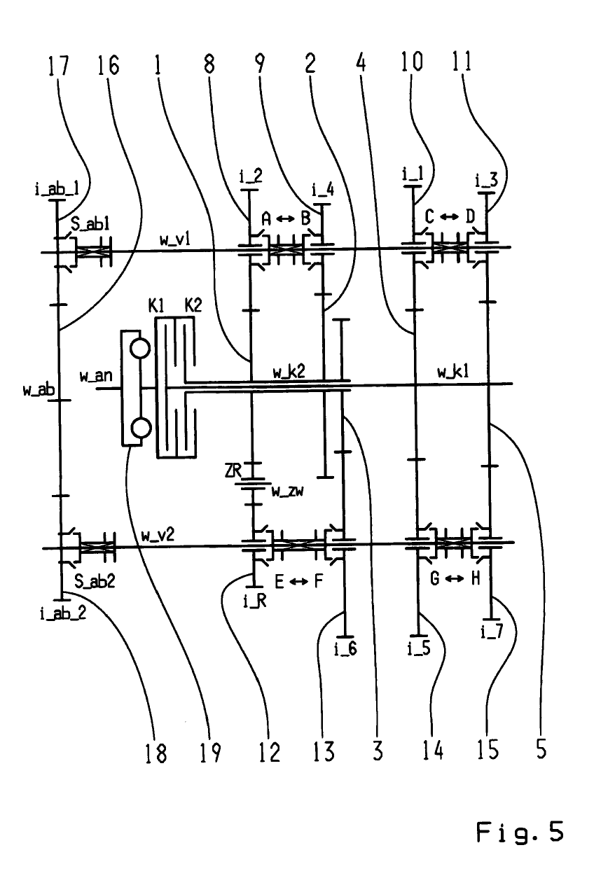

In the 1st, 2nd and 5th variant embodiments according to FIGS. 1, 3 and 9, in the first gear plane 8-12 as a dual gear plane, fixed gear 1 of the second transmission input shaft w_k2 meshes both with idler gear 12 of the second countershaft w_v2 and also with an intermediate gear ZR on an intermediate shaft w_zw for reversing the rotation for the reverse gear transmission ratios, with intermediate gear ZR also meshing with idler gear 8 of the first countershaft w_v1. In the second gear plane 9-2, as a single gear plane, fixed gear 2 of the second transmission input shaft w_k2 meshes with idler gear 9 of the first countershaft w_v1. In the third gear plane 3-13, as a single gear plane, fixed gear 3 of the second transmission input shaft w_k2 meshes with idler gear 13 of the second countershaft w_v2. Furthermore, in the fourth gear plane 10-14 as a dual gear plane, fixed gear 4 of the first transmission input shaft w_k1 meshes both with idler gear 10 of the first countershaft w_v1 and also with idler gear 14 of the second countershaft w_v2. In the fifth gear plane 11-15, as a dual gear plane, fixed gear 5 of the first transmission input shaft w_k1 meshes both with idler gear 11 of the first countershaft w_v1 and also with idler gear 15 of the second countershaft w_v2. The only difference in the 3rd variant embodiment according to FIG. 5 is that in the first gear plane 8-12, as a dual gear plane, fixed gear 1 of the second transmission input shaft w_k2 meshes directly with idler gear 8 of the first transmission shaft w_v1 and is coupled indirectly through an intermediate gear ZR with idler gear 12 of the second countershaft w_v2 for reversing the rotation.

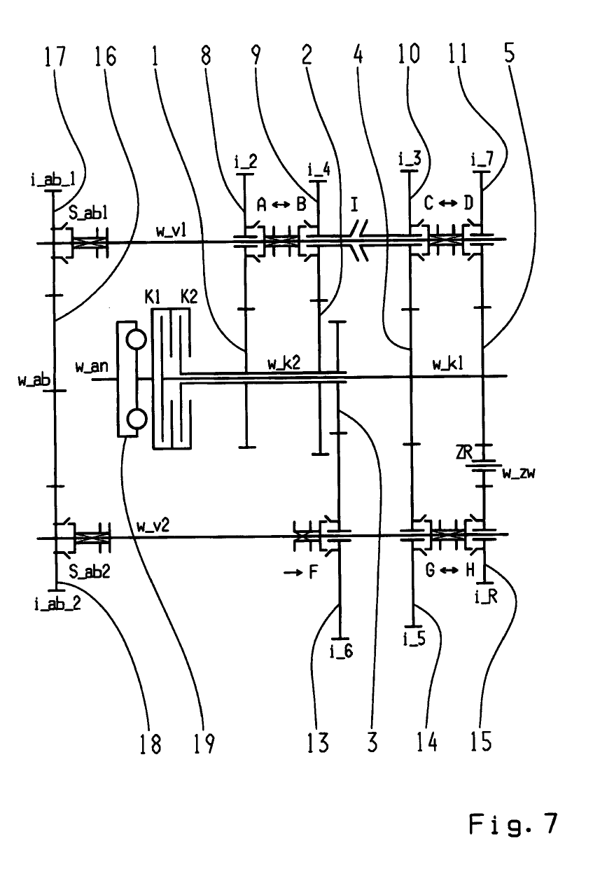

In the 4th variant embodiment according to FIG. 7, in the first gear plane 8-1 as a single gear plane, fixed gear 1 of the second transmission input shaft w_k2 meshes with idler gear 8 of the first transmission shaft w_v1. In the second gear plane 9-2, as a single gear plane, fixed gear 2 of the second transmission input shaft w_k2 meshes with idler gear 9 of the first countershaft w_v1. In the third gear plane 3-13, as a single gear plane, fixed gear 3 of the second transmission input shaft w_k2 meshes with idler gear 13 of the second countershaft w_v2. In addition, in the fourth gear plane 10-14 as a dual gear plane, fixed gear 4 of the first transmission input shaft w_k1 meshes both with idler gear 10 of the first countershaft w_v1 and also with idler gear 14 of the second countershaft w_v2. Finally, in the fifth gear plane 11-15 as a dual gear plane, fixed gear 5 meshes both with idler gear 11 of the first countershaft w_v1 and also with intermediate gear ZR on the intermediate shaft w_zw to reverse the rotation for the reverse gear transmission ratios, with intermediate gear ZR also meshing with idler gear 15 of the second countershaft w_v2.

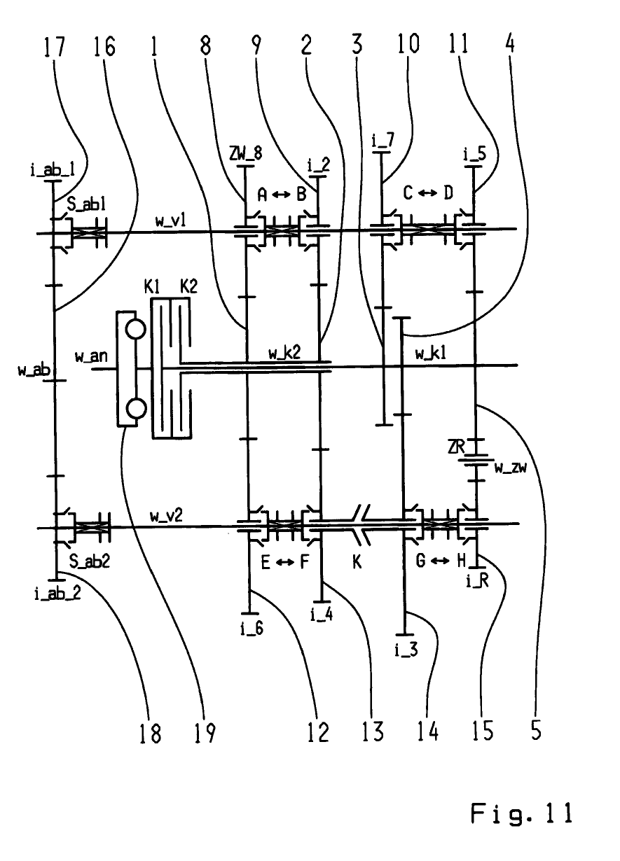

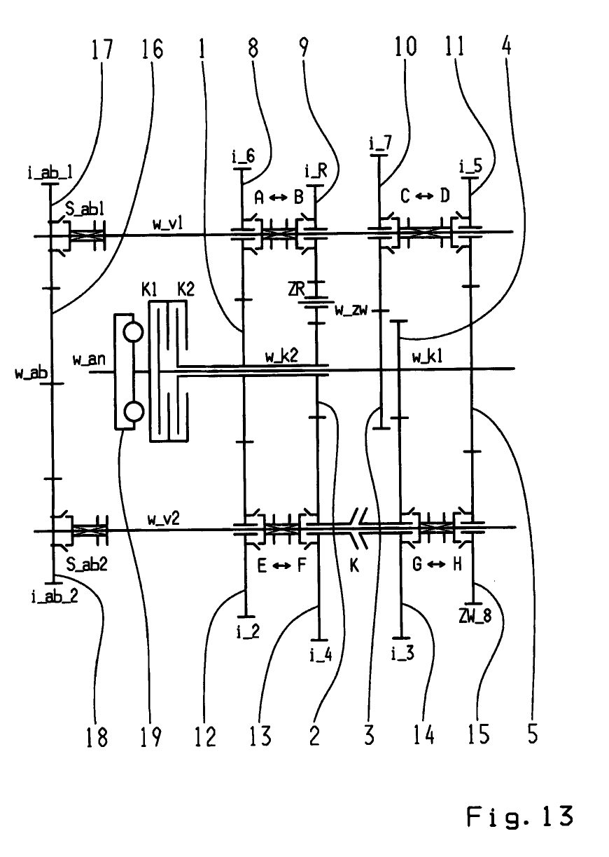

In the 6th and 7th variant embodiments according to FIGS. 11 and 13, in the first gear plane 8-12 as a dual gear plane, fixed gear 1 of the second transmission input shaft w_k2 meshes both with idler gear 8 of the first countershaft w_v1 and also with idler gear 12 of the second countershaft w_v2. In the 6th variant embodiment, in the second gear plane 9-13, as a dual gear plane, fixed gear 2 of the second transmission input shaft w_k2 meshes both with idler gear 9 of the first countershaft w_v1 and also with idler gear 13 of the second countershaft w_v2. In contrast, in the 7th variant embodiment, fixed gear 2 meshes both with idler gear 13 of the second countershaft w_v2 and also with intermediate gear ZR for reversing the rotation for the reverse transmission ratios, with intermediate gear ZR also meshing with idler gear 9 of the first countershaft w_v1. In the third gear plane 10-3, as a single gear plane, in both the 6th and the 7th variant embodiments fixed gear 3 of the second transmission input shaft w_k2 meshes with idler gear 10 of the first countershaft w_v1. In the fifth gear plane 4-14, as a single gear plane, fixed gear 4 of the first transmission input shaft w_k1 meshes with idler gear 14 of the second countershaft w_v2. In the 6th variant embodiment, in the fifth gear plane 11-15, as a dual gear plane, fixed gear 5 of the first transmission input shaft w_k1 meshes both with idler gear 11 of the first countershaft w_v1 and also with intermediate gear ZR for reversing the rotation for the reverse gear transmission ratios, with intermediate gear ZR also meshing with idler gear 15 of the second countershaft w_v2. On the other hand, in the 7th variant embodiment, fixed gear 5 meshes both with idler gear 11 of the first countershaft w_v1 and also with idler gear 15 of the second countershaft w_v2.

In all of the variant embodiments according to FIGS. 1 through 14, in each case two bidirectionally operative coupling device A-B and C-D are provided on the first countershaft w_v1, the coupling devices A-B, C-D being arranged so that the activated coupling device A connects idler gear 8, the activated coupling device B connects idler gear 9, the activated coupling device C connects idler gear 10 and the activated coupling device D connects idler gear 11, in each case to first countershaft w_v1 in a rotationally fixed manner.

In the 1st, 2nd, 3rd, 5th, 6th and 7th variant embodiments according to FIGS. 1, 3, 5, 9, 11 and 13, in each case there are two doubly operative coupling devices E-F and G-H assigned to the second countershaft w_v2, the coupling devices E-F and G-H being arranged so that the activated coupling device E connects idler gear 12, the activated coupling device F connects idler gear 13, the activated coupling device G connects idler gear 14 and the activated coupling device H connects idler gear 15, in each case to second countershaft w_v2 in a rotationally fixed manner.

In the 4th variant embodiment according to FIG. 7, a unidirectionally operative coupling device F and a bidirectionally operative coupling device G-H are assigned to the second countershaft w_v2, the coupling devices F and G-H being arranged so that the activated coupling device F connects idler gear 13, the activated coupling device G connects idler gear 14 and activated coupling device H connects idler gear 15, in each case to the second countershaft w_v2 in a rotationally fixed manner.

Independent of the particular variant embodiments, an integrated output stage with the output gear 17 and with the output gear 18 is provided in the double clutch transmission according to the invention. Output gear 17 and output gear 18 each mesh with a fixed gear 16 of output shaft w_ab. Preferably, shiftable connections are realized between output gears 17, 18 and the assigned countershafts w_v1, w_v2 by the shiftable coupling devices S_ab1, S_ab2.

Another result in the double clutch transmission according to the invention is that at least the forward gears G1 through G7 may be designed to be power shiftable. Depending on the variant embodiment, the eighth forward gear G8, reverse gears, crawler gears and/or overdrive gears can be designed to be power shiftable as winding path gears. Details for each variant embodiment will be evident from the shift patterns described below.

The table depicted in FIG. 2 shows an example of a shift pattern for the 1st variant embodiment of the eight-speed double clutch transmission according to FIG. 1.

It is evident from the shift pattern that the first forward gear G1 is shiftable by means of the first clutch K1, the activated coupling device B, the activated coupling device D and the activated coupling device E, and also as a winding path gear when coupling device S_ab1 is disengaged, that the second forward gear G2 is shiftable by means of the second clutch K2 and the activated coupling device E, that the third forward gear G3 is shiftable by means of the first clutch K1 and the activated coupling device D, that the fourth forward gear G4 is shiftable by means of the second clutch K2 and the activated coupling device B, that the fifth forward gear G5 is shiftable by means of the first clutch K1 and the activated coupling device G, that the sixth forward gear G6 is shiftable by means of the second clutch K2 and the activated coupling device F, and that the seventh forward gear G7 is shiftable by means of the first clutch K1 and the activated coupling device C. Thus, at least the first seven forward gears can be designed to be power shiftable. Furthermore, the eighth forward gear G8 can be shifted by means of the second clutch K2, the activated coupling device D, the activated coupling device F and the activated coupling device H, and also as a winding path gear when coupling device S_ab2 is disengaged.

Furthermore, a reverse gear R1 for example can be shifted by means of the second clutch K2, the activated coupling device A, the activated coupling device C and the activated coupling device H and also as a winding path gear when coupling device S_ab1 is disengaged, a reverse gear R2 can be shifted by means of the first clutch K1, the activated coupling device A, the activated coupling device D and the activated coupling device E and also as a winding path gear when coupling device S_ab1 is disengaged, a reverse gear R3 can be shifted by means of the first clutch K1, the activated coupling device A, the activated coupling device F and the activated coupling device H and also as a winding path gear when coupling device S_ab2 is disengaged.

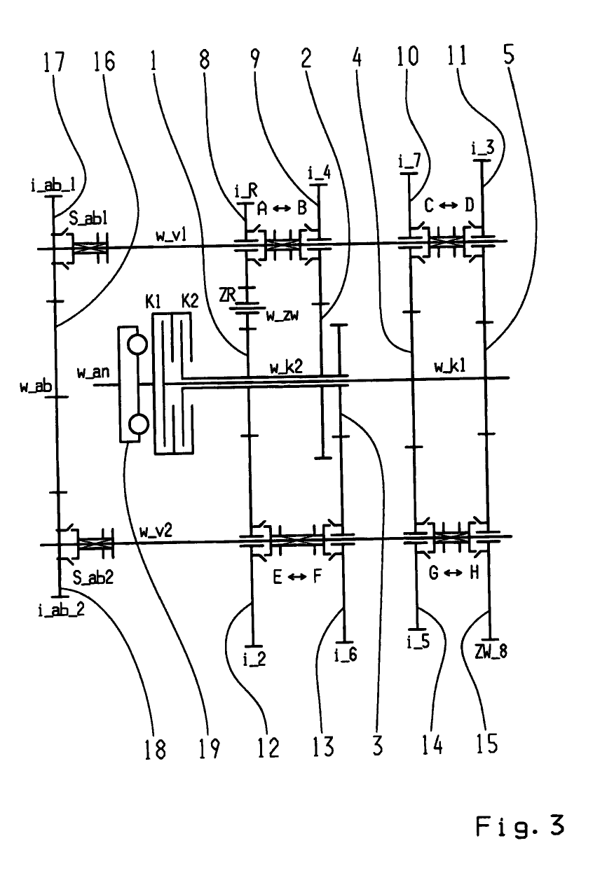

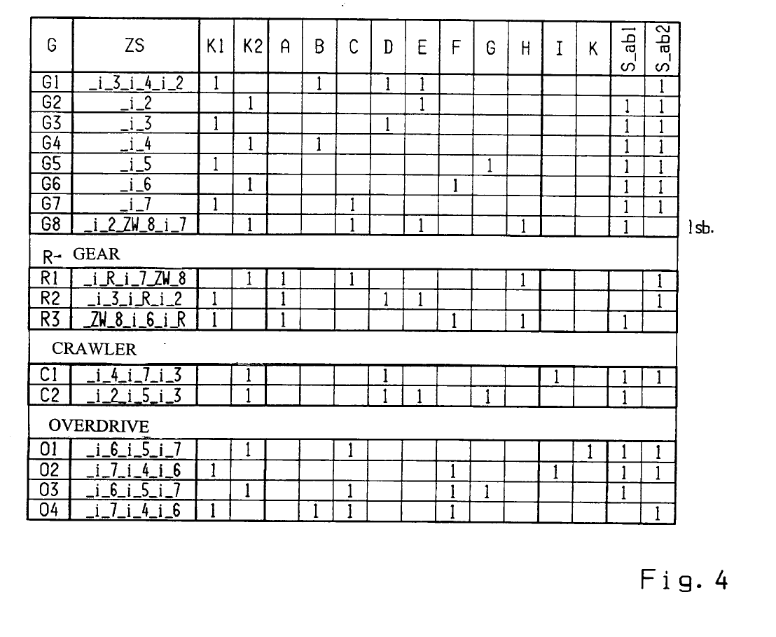

The table depicted in FIG. 4 shows an example of a shift pattern for the 2nd variant embodiment of the eight-speed double clutch transmission according to FIG. 3.

It is evident from the shift pattern that the first forward gear G1 is shiftable by means of the first clutch K1, the activated coupling device B, the activated coupling device D and the activated coupling device E, and also as a winding path gear when coupling device S_ab1 is disengaged, that the second forward gear G2 is shiftable by means of the second clutch K2 and the activated coupling device E, that the third forward gear G3 is shiftable by means of the first clutch K1 and the activated coupling device D, that the fourth forward gear G4 is shiftable by means of the second clutch K2 and the activated coupling device B, that the fifth forward gear G5 is shiftable by means of the first clutch K1 and the activated coupling device G, that the sixth forward gear G6 is shiftable by means of the second clutch K2 and the activated coupling device F, that the seventh forward gear G7 is shiftable by means of the first clutch K1 and the activated coupling device C, and that the eighth forward gear G8 is shiftable by means of the second clutch K2, the activated coupling device C, the activated coupling device E and the activated coupling device H, and also as a winding path gear when coupling device S_ab2 is disengaged. Thus, at least the first eight forward gears can be designed to be power shiftable.

Furthermore, in the 4th variant embodiment it is possible for a reverse gear R1 to be shifted by means of the second clutch K2, the activated coupling device A, the activated coupling device C and the activated coupling device H and also as a winding path gear when coupling device S_ab1 is disengaged, a reverse gear R2 to be shifted by means of the first clutch K1, the activated coupling device A, the activated coupling device D, the activated coupling device E and also as a winding path gear when coupling device S_ab1 is disengaged, a reverse gear R3 to be shifted by means of the first clutch K1, the activated coupling device A, the activated coupling device F and the activated coupling device H, and also as a winding path gear when coupling device S_ab2 is disengaged.

Furthermore, the tables depicted in FIGS. 2 and 4 show shift patterns respectively for the 1st and 2nd variant embodiments according to FIGS. 1 and 3.

Accordingly, in the 1st and 2nd variant embodiments for example a crawler gear C1 can be shifted by means of the second clutch K2 and the activated coupling device D, and also as a winding path gear when shift element I is activated, a crawler gear C2 can be shifted by means of the second clutch K2, the activated coupling device D, the activated coupling device E and the activated coupling device G, and also as a winding path gear when coupling device S_ab2 is disengaged, an overdrive gear O1 can be shifted by means of the second clutch K2 and the activated coupling device C, and also as a winding path gear by means of the activated shift element K, an overdrive gear O2 can be shifted by means of the first clutch K1 and the activated coupling device F, and also as a winding path gear by means of the activated shift element I, an overdrive gear O3 can be shifted by means of the second clutch K2, the activated coupling device C, the activated coupling device F and the activated coupling device G, and also as a winding path gear when coupling device S_ab2 is disengaged, an overdrive gear O4 can be shifted by means of the first clutch K1, the activated coupling device B, the activated coupling device C and the activated coupling device F, and also as a winding path gear when coupling device S_ab1 is disengaged.

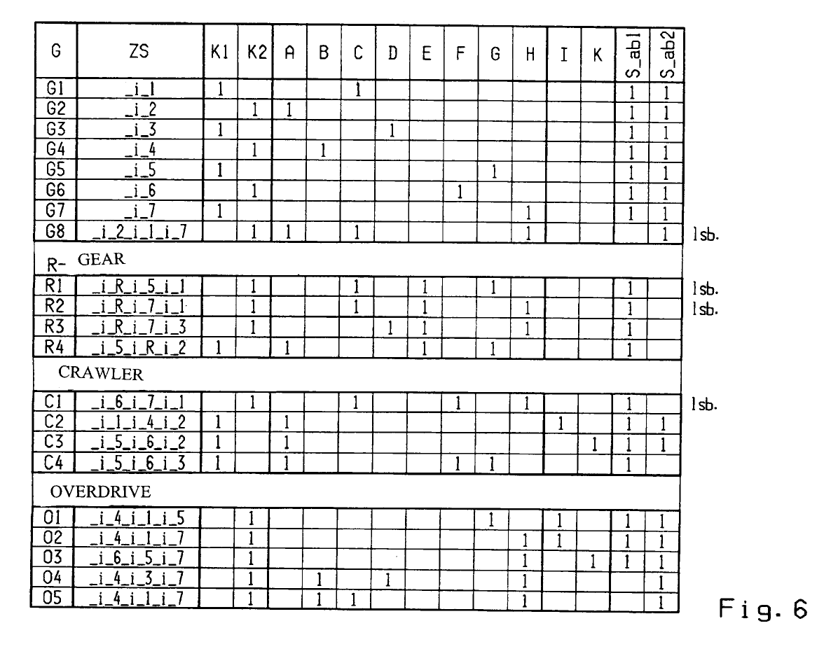

The table depicted in FIG. 6 shows an example of a shift pattern for the 3rd variant embodiment of the eight-speed double clutch transmission according to FIG. 5.

It is evident from the shift pattern that the first forward gear G1 is shiftable by means of the first clutch K1 and the activated coupling device C, that the second forward gear G2 is shiftable by means of the second clutch K2 and the activated coupling device A, that the third forward gear G3 is shiftable by means of the first clutch K1 and the activated coupling device D, that the fourth forward gear G4 is shiftable by means of the second clutch K2 and the activated coupling device B, that the fifth forward gear G5 is shiftable by means of the first clutch K1 and the activated coupling device G, that the sixth forward gear G6 is shiftable by means of the second clutch K2 and the activated coupling device F, that the seventh forward gear G7 is shiftable by means of the first clutch K1 and the activated coupling device H, and that the eighth forward gear G8 is shiftable by means of the second clutch K2, the activated coupling device A, the activated coupling device C and the activated coupling device H, and also as a winding path gear when coupling device S_ab1 is disengaged. Thus, at least the first eight forward gears can be designed to be power shiftable.

Furthermore, a reverse gear R1 can be shifted by means of the second clutch K2, the activated coupling device C, the activated coupling device E and the activated coupling device G, and also as a winding path gear when coupling device S_ab2 is disengaged, that a reverse gear R2 can be shifted by means of the second clutch K2, the activated coupling device C, the activated coupling device E and the activated coupling device H, and also as a winding path gear when coupling device S_ab2 is disengaged, a reverse gear R3 can be shifted by means of the second clutch K2, the activated coupling device D, the activated coupling device E and the activated coupling device H, and also as a winding path gear when coupling device S_ab2 is disengaged, and/or a reverse gear R4 can be shifted by means of the first clutch K1, the activated coupling device A, the activated coupling device E and the activated coupling device G, and also as a winding path gear when coupling device S_ab2 is disengaged.

Advantageously, in the 3rd variant embodiment the reverse gears R1, R2 are power shiftable to the first forward gear (R1, R2 lsb. to G1).

Furthermore, in the 3rd variant embodiment a crawler gear C1 can be shifted by means of the second clutch K2, the activated coupling device C, the activated coupling device F and the activated coupling device H, and also as a winding path gear when coupling device S_ab2 is disengaged, a crawler gear C2 can be shifted by means of the first clutch K1 and the activated coupling device A, and also as a winding path gear by means of the activated shift element I, a crawler gear C3 can be shifted by means of the first clutch K1 and the activated coupling device A, and also as a winding path gear by means of the activated shift element K, and a crawler gear C4 can be shifted by means of the first clutch K1, the activated coupling device A, the activated coupling device F and the activated coupling device G, and also as a winding path gear when coupling device S_ab2 is disengaged.

Especially advantageously, the crawler gear C1 can be designed to be power shiftable to the first forward gear (C1 lsb. to G1).

Finally, an overdrive gear O1 can also be shifted by means of the second clutch K2 and the activated coupling device G, and also as a winding path gear by means of the activated shift element I, an overdrive gear O2 can be shifted by means of the second clutch K2 and the activated coupling device H, and also as a winding path gear by means of the activated shift element I, an overdrive gear O3 can be shifted by means of the second clutch K2 and the activated coupling device H, and also as a winding path gear by means of the activated shift element K, an overdrive gear O4 can be shifted by means of the second clutch K2, the activated coupling device B, the activated coupling device D and the activated coupling device H, and also as a winding path gear when coupling device S_ab1 is disengaged, and an overdrive gear O5 can be shifted by means of the second clutch K2, the activated coupling device B, the activated coupling device C and the activated coupling device H, and also as a winding path gear when coupling device S_ab1 is disengaged.

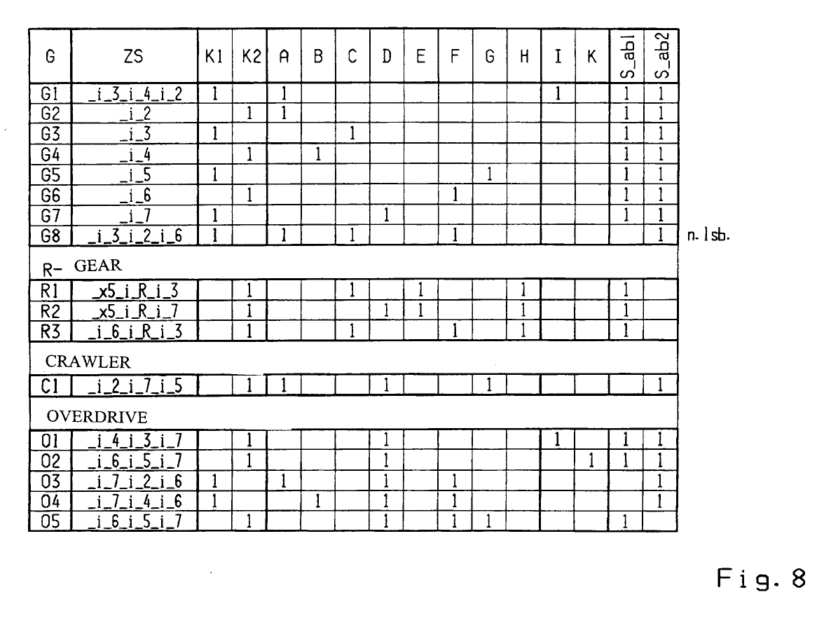

The table depicted in FIG. 8 shows an example of a shift pattern for the 4th variant embodiment of the eight-speed double clutch transmission according to FIG. 7.

It is evident from the shift pattern that the first forward gear G1 is shiftable by means of the first clutch K1 and the activated coupling device A, and also as a winding path gear by means of the activated shift element I, that the second forward gear G2 is shiftable by means of the second clutch K2 and the activated coupling device A, that the third forward gear G3 is shiftable by means of the first clutch K1 and the activated coupling device C, that the fourth forward gear G4 is shiftable by means of the second clutch K2 and the activated coupling device B, that the fifth forward gear G5 is shiftable by means of the first clutch K1 and the activated coupling device G, that the sixth forward gear G6 is shiftable by means of the second clutch K2 and the activated coupling device F, and that the seventh forward gear G7 is shiftable by means of the first clutch K1 and the activated coupling device D. Thus, at least the first seven forward gears can be designed to be power shiftable. Furthermore, the eighth forward gear G8 can be shifted by means of the first clutch K1, the activated coupling device A, the activated coupling device C and the activated coupling device F, and also as a winding path gear when coupling device S_ab1 is disengaged.

Furthermore, in the 4th variant embodiment a reverse gear R1 can be shifted by means of the second clutch K2, the activated coupling device C, the activated coupling device E and the activated coupling device H, and also as a winding path gear when coupling device S_ab2 is disengaged, a reverse gear R2 can be shifted by means of the second clutch K2, the activated coupling device D, the activated coupling device E, the activated coupling device H, and also as a winding path gear when coupling device S_ab2 is disengaged, and a reverse gear R3 can be shifted by means of the second clutch K2, the activated coupling device C, the activated coupling device F and the activated coupling device H, and also as a winding path gear when coupling device S_ab2 is disengaged.

Further, a crawler gear C1 can also be shifted by means of the second clutch K2, the activated coupling device A, the activated coupling device D and the activated coupling device G, and also as a winding path gear when coupling device S_ab1 is disengaged.

Finally, an overdrive gear O1 can also be shifted by means of the second clutch K2 and the activated coupling device D, and also as a winding path gear by means of the activated shift element I, an overdrive gear O2 can be shifted by means of the second clutch K2 and the activated coupling device D, and also as a winding path gear by means of the activated shift element K, an overdrive gear O3 can be shifted by means of the first clutch K1, the activated coupling device A, the activated coupling device D and the activated coupling device F, and also as a winding path gear when coupling device S_ab1 is disengaged, an overdrive gear O4 can be shifted by means of the first clutch K1, the activated coupling device B, the activated coupling device D and the activated coupling device F, and also as a winding path gear when coupling device S_ab1 is disengaged, and an overdrive gear O5 can be shifted by means of the second clutch K2, the activated coupling device D, the activated coupling device F and the activated coupling device G, and also as a winding path gear when coupling device S_ab2 is disengaged.

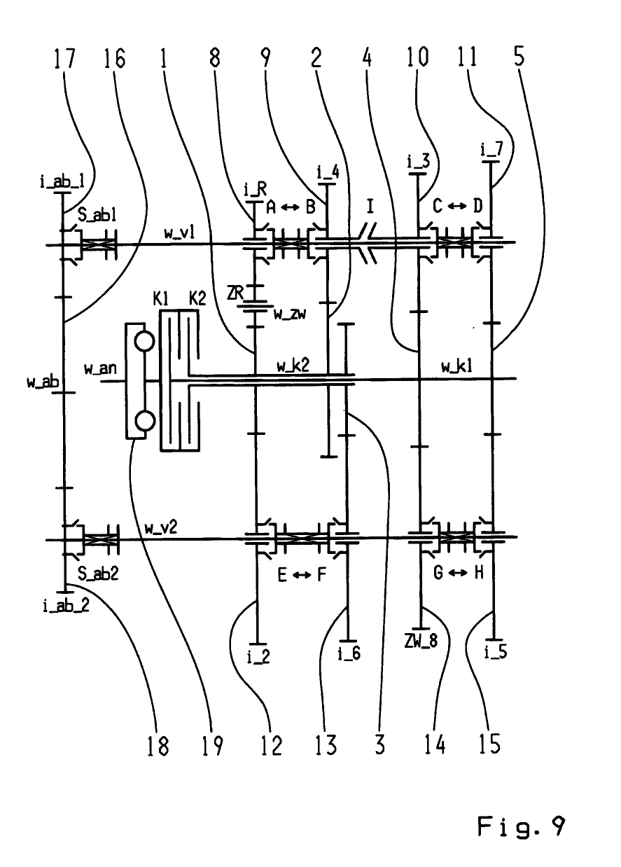

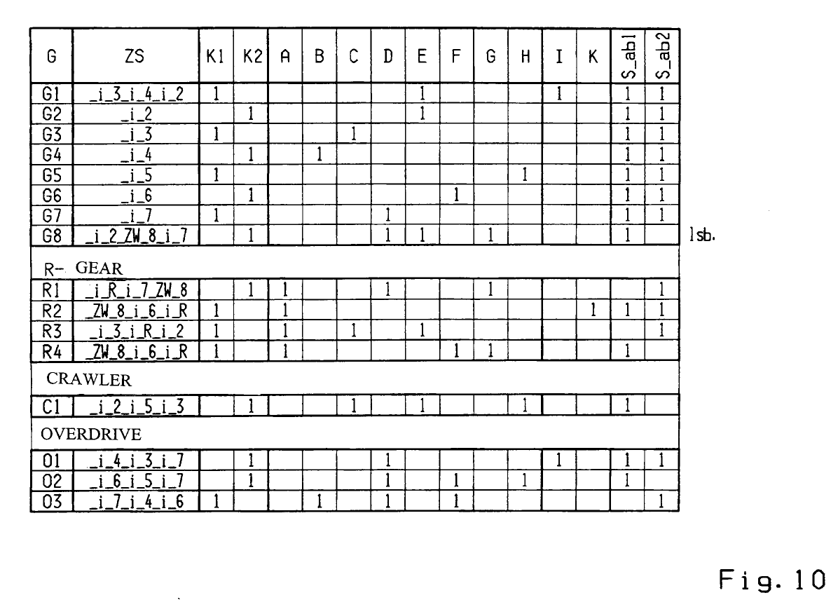

The table depicted in FIG. 10 shows an example of a shift pattern for the 5th variant embodiment of the eight-speed double clutch transmission according to FIG. 9.

It is evident from the shift pattern that the first forward gear G1 is shiftable by means of the first clutch K1 and the activated coupling device E, and also as a winding path gear by means of the activated shift element I, that the second forward gear G2 is shiftable by means of the second clutch K2 and the activated coupling device E, that the third forward gear G3 is shiftable by means of the first clutch K1 and the activated coupling device C, that the fourth forward gear G4 is shiftable by means of the second clutch K2 and the activated coupling device B, that the fifth forward gear G5 is shiftable by means of the first clutch K1 and the activated coupling device H, that the sixth forward gear G6 is shiftable by means of the second clutch K2 and the activated coupling device F, that the seventh forward gear G7 is shiftable by means of the first clutch K1 and the activated coupling device D, and that the eighth forward gear G8 is shiftable by means of the second clutch K2, the activated coupling device D, the activated coupling device E and the activated coupling device G, and also as a winding path gear when coupling device S_ab2 is disengaged. Thus, at least the first eight forward gears can be designed to be power shiftable.

Furthermore, in the 5th variant embodiment a reverse gear R1 can be shifted by means of the second clutch K2, the activated coupling device A, the activated coupling device D and the activated coupling device G, and also as a winding path gear when coupling device S_ab1 is disengaged, a reverse gear R2 can be shifted by means of the first clutch K1 and the activated coupling device A, and also as a winding path gear by means of activated shift element K, a reverse gear R3 can be shifted by means of the first clutch K1, the activated coupling device A, the activated coupling device C and the activated coupling device E, and also as a winding path gear when coupling device S_ab1 is disengaged, and a reverse gear R4 can be shifted by means of the first clutch K1, the activated coupling device A, the activated coupling device F and the activated coupling device G, and also as a winding path gear when coupling device S_ab2 is disengaged.

A crawler gear C1 can also be shifted by means of the second clutch K2, the activated coupling device C, the activated coupling device E and the activated coupling device H, and also as a winding path gear when coupling device S_ab2 is disengaged.

Finally, an overdrive gear O1 can be shifted by means of the second clutch K2 and the activated coupling device D, and also as a winding path gear by means of the activated shift element I, an overdrive gear O2 can be shifted by means of the second clutch K2, the activated coupling device D, the activated coupling device F and the activated coupling device H, and also as a winding path gear when coupling device S_ab2 is disengaged, an overdrive gear O3 can be shifted by means of the first clutch K1, the activated coupling device B, the activated coupling device D and the activated coupling device F, and also as a winding path gear when coupling device S_ab1 is disengaged.

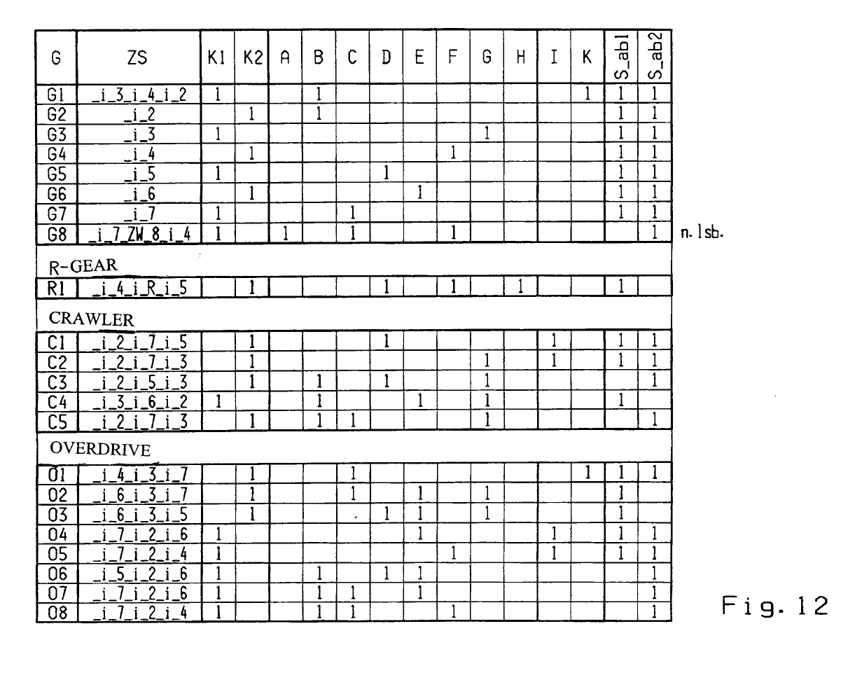

The table depicted in FIG. 12 shows an example of a shift pattern for the 6th variant embodiment of the eight-speed double clutch transmission according to FIG. 11.

It is evident from the shift pattern that the first forward gear G1 is shiftable by means of the first clutch K1 and the activated coupling device B, and also as a winding path gear by means of the activated shift element K, that the second forward gear G2 is shiftable by means of the second clutch K2 and the activated coupling device B, that the third forward gear G3 is shiftable by means of the first clutch K1 and the activated coupling device G, that the fourth forward gear G4 is shiftable by means of the second clutch K2 and the activated coupling device F, that the fifth forward gear G5 is shiftable by means of the first clutch K1 and the activated coupling device D, that the sixth forward gear G6 is shiftable by means of the second clutch K2 and the activated coupling device E, and that the seventh forward gear G7 is shiftable by means of the first clutch K1 and the activated coupling device C. Thus, at least the first seven forward gears can be designed to be power shiftable. Furthermore, the eighth forward gear G8 can be shifted by means of the first clutch K1, the activated coupling device A, the activated coupling device C and the activated coupling device F, and also as a winding path gear when coupling device S_ab1 is disengaged.

Moreover, in the 6th variant embodiment a reverse gear R1 can be shifted by means of the second clutch K2, the activated coupling device D, the activated coupling device F and the activated coupling device H, and also as a winding path gear when coupling device S_ab2 is disengaged.

Also, a crawler gear C1 can be shifted by means of the second clutch K2 and the activated coupling device D, and also as a winding path gear by means of the activated shift element I, a crawler gear C2 can be shifted by means of the second clutch K2 and the activated coupling device G, and also as a winding path gear by means of the activated shift element I, a crawler gear C3 can be shifted by means of the second clutch K2, the activated coupling device B, the activated coupling device D and the activated coupling device G, and also as a winding path gear when coupling device S_ab1 is disengaged, a crawler gear C4 can be shifted by means of the first clutch K1, the activated coupling device B, the activated coupling device E and the activated coupling device G, and also as a winding path gear when coupling device S_ab2 is disengaged, and a crawler gear C5 can be shifted by means of the second clutch K2, the activated coupling device B, the activated coupling device C and the activated coupling device G, and also as a winding path gear when coupling device S_ab1 is disengaged.

Finally, an overdrive gear O1 can also be shifted by means of the second clutch K2 and the activated coupling device C, and also as a winding path gear by means of the activated shift element K, an overdrive gear O2 can be shifted by means of the second clutch K2, the activated coupling device C, the activated coupling device E and the activated coupling device G, and also as a winding path gear when coupling device S_ab2 is disengaged, an overdrive gear O3 can be shifted by means of the second clutch K2, the activated coupling device D, the activated coupling device E and the activated coupling device G, and also as a winding path gear when coupling device S_ab2 is disengaged, an overdrive gear O4 can be shifted by means of the first clutch K1 and the activated coupling device E, and also as a winding path gear by means of the activated shift element I, an overdrive gear O5 can be shifted by means of the first clutch K1 and the activated coupling device F, and also as a winding path gear by means of the activated shift element I, an overdrive gear O6 can be shifted by means of the first clutch K1, the activated coupling device B, the activated coupling device D and the activated coupling device E, and also as a winding path gear when coupling device S_ab1 is disengaged, an overdrive gear O7 can be shifted by means of the first clutch K1, the activated coupling device B, the activated coupling device C and the activated coupling device E, and also as a winding path gear when coupling device S_ab1 is disengaged, and an overdrive gear O8 can be shifted by means of the first clutch K1, the activated coupling device B, the activated coupling device C and the activated coupling device F, and also as a winding path gear when coupling device S_ab1 is disengaged.

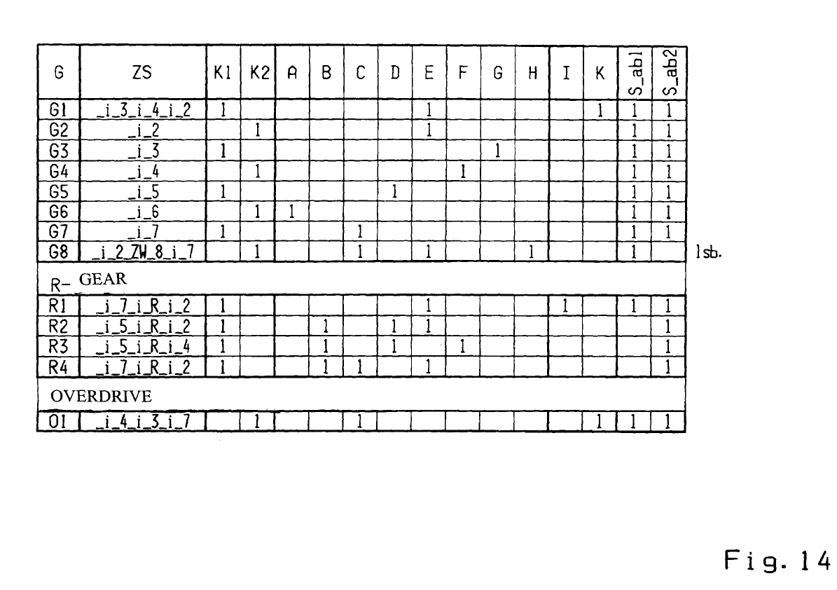

The table depicted in FIG. 14 shows an example of a shift pattern for the 7th variant embodiment of the eight-speed double clutch transmission according to FIG. 13.

It is evident from the shift pattern that the first forward gear G1 is shiftable by means of the first clutch K1 and the activated coupling device E, and also as a winding path gear by means of the activated shift element K, that the second forward gear G2 is shiftable by means of the second clutch K2 and the activated coupling device E, that the third forward gear G3 is shiftable by means of the first clutch K1 and the activated coupling device G, that the fourth forward gear G4 is shiftable by means of the second clutch K2 and the activated coupling device F, that the fifth forward gear G5 is shiftable by means of the first clutch K1 and the activated coupling device D, that the sixth forward gear G6 is shiftable by means of the second clutch K2 and the activated coupling device A, that the seventh forward gear G7 is shiftable by means of the first clutch K1 and the activated coupling device C, and that the eighth forward gear G8 is shiftable by means of the second clutch K2, the activated coupling device C, the activated coupling device E and the activated coupling device H, and also as a winding path gear when coupling device S_ab2 is disengaged. Thus, at least the first eight forward gears can be designed to be power shiftable.

Furthermore, in the 7th variant embodiment a reverse gear R1 can be shifted by means of the first clutch K1 and the activated coupling device E, and also as a winding path gear by means of the activated shift element I, a reverse gear R2 can be shifted by means of the first clutch K1, the activated coupling device B, the activated coupling device D and the activated coupling device E, and also as a winding path gear when coupling device S_ab1 is disengaged, a reverse gear R3 can be shifted by means of the first clutch K1, the activated coupling device B, the activated coupling device D and the activated coupling device F, and also as a winding path gear when coupling device S_ab1 is disengaged, and a reverse gear R4 can be shifted by means of the first clutch K1, the activated coupling device B, the activated coupling device C and the activated coupling device E, and also as a winding path gear when coupling device S_ab1 is disengaged.

Finally, an overdrive gear O1 can also be shifted by means of the second clutch K2 and the activated coupling device C, and also as a winding path gear by means of the activated shift element K.

The shift pattern according to FIG. 2 shows in detail that in the first forward gear G1, starting from the first clutch K1 the gear stages i_3, i_4 and i_2 are used, with the coupling of the two subtransmissions occurring with coupling device S_ab1 disengaged. The second forward gear G2 uses gear stage i_2, the third forward gear G3 uses gear stage the fourth forward gear G4 uses gear stage i_4, the fifth forward gear G5 uses gear stage i_5, the sixth forward gear G6 uses gear stage i_6 and the seventh forward gear G7 uses gear stage i_7. In the eighth forward gear G8, starting from the second clutch K2 the gear stages or gear steps i_6, ZW_8, and i_3 are used, with the two subtransmissions being coupled in the first variant embodiment with coupling device S_ab2 disengaged.

In addition, in reverse gear R1, starting from the second clutch K2, gear stages i_R, i_7 and ZW_8 are used, the two subtransmissions being coupled to each other when coupling device S_ab1 is disengaged. Furthermore, the next reverse gear R2, starting from the first clutch K1, uses the gear stages i_3, i_R and i_2, the coupling device S_ab1 being disengaged to couple the two subtransmissions. The reverse gear R3, starting from the first clutch K1, uses the gear stages ZW_8, i_6 and i_R, the two subtransmissions being coupled to each other when coupling device S_ab2 is disengaged. The crawler gear C1, starting from the second clutch K2, uses the gear stages i_4, i_7 and i_3, the two subtransmissions being coupled with each other when shift element I is activated. The crawler gear C2, starting from the second clutch K2, uses the gear stages i_2, i_5 and i_3, the two subtransmissions being coupled when coupling device S_ab2 is disengaged. The overdrive gear O1, starting from the second clutch K2, uses the gear stages i_6, i_5 and i_7, the two subtransmissions being coupled by means of the activated shift element K. The overdrive gear O2, starting from the first clutch K1, uses the gear stages i_7, i_4 and i_6, the two subtransmissions being coupled when shift element I is activated. The overdrive gear O3, starting from the second clutch K2, uses the gear stages i_6, i_5 and i_7, the two subtransmissions being coupled when coupling device S_ab2 is disengaged. The overdrive gear O4, starting from the first clutch K1, uses the gear stages i_7, i_4 and i_6, the two subtransmissions being coupled when coupling device S_ab1 is disengaged.

The shift pattern according to FIG. 4 shows in detail that in the first forward gear G1, starting from the first clutch K1 the gear stages i_3, i_4 and i_2 are used, with the coupling of the two subtransmissions occurring when coupling device S_ab1 is disengaged. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. In the eighth forward gear G8, starting from the second clutch K2, the gear stages or gear steps i_2, ZW_8, and i_7 are used, with the two subtransmissions being coupled with coupling device S_ab2 disengaged in the first variant embodiment.

In addition, in reverse gear R1, starting from the second clutch K2, gear stages i_R, i_7 and ZW_8 are used, the two subtransmissions being coupled to each other when coupling device S_ab1 is disengaged. Furthermore, the next reverse gear R2, starting from the first clutch K1, uses the gear stages i_3, i_R and i_2, the coupling device S_ab1 being disengaged to couple the two subtransmissions. The reverse gear R3, starting from the first clutch K1, uses the gear stages ZW_8, i_6 and i_R, the two subtransmissions being coupled to each other when coupling device S_ab2 is disengaged.

The crawler gear C1, starting from the second clutch K2, uses the gear stages i_4, i_7 and i_3, the two subtransmissions being coupled with each other when shift element I is activated. The crawler gear C2, starting from the second clutch K2, uses the gear stages i_2, i_5 and i_3, the two subtransmissions being coupled when coupling device S_ab2 is disengaged. The overdrive gear O1, starting from the second clutch K2, uses the gear stages i_6, i_5 and i_7, the two subtransmissions being coupled by means of the activated shift element K. The overdrive gear O2, starting from the first clutch K1, uses the gear stages i_7, i_4 and i_6, the two subtransmissions being coupled when shift element I is activated. The overdrive gear O3, starting from the second clutch K2, uses the gear stages i_6, i_5 and i_7, the two subtransmissions being coupled when coupling device S_ab2 is disengaged. The overdrive gear O4, starting from the first clutch K1, uses the gear stages i_7, i_4 and i_6, the two subtransmissions being coupled when coupling device S_ab1 is disengaged.

The shift pattern according to FIG. 6 shows in detail that the first forward gear G1, starting from the first clutch K1, uses gear stage i_1. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. The eighth forward gear G8, starting from the second clutch K2, uses the gear stages i_2, i_1 and i_7, the coupling device S_ab1 being disengaged to couple the two subtransmissions. In addition, the reverse gear R1, starting from the second clutch K2, gear stages uses the gear stages, i_R, i_5 and i_1, the two subtransmissions being coupled to each other when coupling device S_ab2 is disengaged. The reverse gear R2, starting from the second clutch K2, uses the gear stages i_R, i_7 and i_1, the two subtransmissions being coupled to each other in reverse gear R2 when coupling device S_ab2 is disengaged. The reverse gear R3, starting from the second clutch K2, uses the gear stages i_R, i_7 and i_3, the two subtransmissions being coupled with each other when coupling device S_ab2 is disengaged. The reverse gear R4, starting from the first clutch K1, uses the gear stages i_5, i_R and i_2, the two subtransmissions being coupled to each other when coupling device S_ab2 is disengaged.

Furthermore, the crawler gear C1, starting from the second clutch K2, uses the gear stages i_6, i_7 and i_1, the subtransmissions being coupled when coupling device S_ab2 is disengaged. The crawler gear C2, starting from the first clutch K1, uses the gear stages i_1, i_4 and i_2, the subtransmissions being coupled when shift element I is activated. The crawler gear C3, starting from the first clutch K1, uses the gear stages i_5, i_6 and i_2, the subtransmissions being coupled when shift element K is activated. The crawler gear C4, starting from the first clutch K1, uses the gear stages i_5, i_6 and i_3, the subtransmissions being coupled when coupling device S_ab2 is disengaged. The overdrive gear O1, starting from the second clutch K2, uses the gear stages i_4, i_1 and i_5, the two subtransmissions being coupled to each other by means of the activated shift element I. The overdrive gear O2, starting from the second clutch K2, uses the gear stages i_4, i_1 and i_7, the two subtransmissions being coupled to each other by means of the activated shift element I. The overdrive gear O3, starting from the second clutch K2, uses the gear stages i_6, i_5 and i_7, the two subtransmissions being coupled to each other by means of the activated shift element K. The overdrive gear O4, starting from the second clutch K2, uses the gear stages i_4, i_3 and i_7, the two subtransmissions being coupled to each other when coupling device S_ab1 is disengaged. The overdrive gear O5, starting from the second clutch K2, uses the gear stages i_4, i_1 and i_7, the two subtransmissions being coupled to each other when coupling device S_ab1 is disengaged.

The shift pattern according to FIG. 8 shows in detail that the first forward gear G1, starting from the first clutch K1, uses the gear stages i_3, i_4 and i_2, the two subtransmissions being coupled when shift element I is activated. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. The eighth forward gear G8, starting from the first clutch K1, uses the gear stages i_3, i_2 and i_6, the two subtransmissions being coupled when coupling device S_ab1 is disengaged. In addition, the reverse gear R1, starting from the second clutch K2, uses the gear stages _x5, i_R and i_3, the two subtransmissions being coupled when coupling device S_ab2 is disengaged. The reverse gear R2, starting from the second clutch K2, uses the gear stages _x5, i_R and i_7, the two subtransmissions being coupled when coupling device S_ab2 is disengaged. The reverse gear R3, starting from the second clutch K2, uses the gear stages i_6, i_R and i_3, the two subtransmissions being coupled when coupling device S_ab2 is disengaged.

The crawler gear C1, starting from the second clutch K2, uses the gear stages i_2, i_7 and i_5, the two subtransmissions being coupled when a coupling device S_ab1 is disengaged. In addition, the overdrive gear O1, starting from the second clutch K2, uses the gear stages i_4, i_3 and i_7, the two subtransmissions being coupled with each other by means of the shift element I. The overdrive gear O2, starting from the second clutch K2, uses the gear stages i_6, i_5 and i_7, the two subtransmissions being coupled with each other by means of the shift element K. The overdrive gear O3, starting from the first clutch K1, uses the gear stages i_7, i_2 and i_6, the two subtransmissions being coupled when coupling device S_ab1 is disengaged. The overdrive gear O4, starting from the first clutch K1, uses the gear stages i_7, i_4 and i_6, the two subtransmissions being coupled when a coupling device S_ab1 is disengaged. The overdrive gear O5, starting from the second clutch K2, uses the gear stages i_6, i_5 and i_7, the two subtransmissions being coupled when a coupling device S_ab2 is disengaged.

The shift pattern according to FIG. 10 shows in detail that in the first forward gear G1, starting from the first clutch K1, the gear stages i_3, i_4 and i_2 are used, the subtransmissions being coupled by means of the activated shift element I. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. The eighth forward gear G8, starting from the second clutch K2, uses the gear stages i_2, ZW_8 and i_7, the subtransmissions being coupled when coupling device S_ab2 is disengaged. In addition, the reverse gear R1, starting from the second clutch K2, uses the gear stages i_R, i_7 and ZW_8, the subtransmissions being coupled when coupling device S_ab1 is disengaged. The reverse gear R2, starting from the first clutch K1, uses the gear stages ZW_8, i_6 and i_R, the subtransmissions being coupled when shift element K is activated. The reverse gear R3, starting from the first clutch K1, uses the gear stages i_3, i_R and i_2, the subtransmissions being coupled when coupling device S_ab1 is disengaged. The reverse gear R4, starting from the first clutch K1, uses the gear stages ZW_8, i_6 and i_R, the subtransmissions being coupled when coupling device S_ab2 is disengaged.

In addition, the crawler gear C1, starting from the second clutch K2, uses the gear stages i_2, i_5 and i_3, the two subtransmissions being coupled to each other when coupling device S_ab2 is disengaged. The overdrive gear O1, starting from the second clutch K2, uses the gear stages i_4, i_3 and i_7, the two subtransmissions being coupled to each other by means of a shift element I. In addition, the overdrive gear O2, starting from the second clutch K2, uses the gear stages i_6, i_5 and i_7, the two subtransmissions being coupled to each other when coupling device S_ab2 is disengaged. The overdrive gear O3, starting from the first clutch K1, uses the gear stages i_7, i_4 and i_6, the two subtransmissions being coupled when coupling device S_ab1 is disengaged.

The shift pattern according to FIG. 12 shows in detail that the first forward gear G1, starting from the first clutch K1, uses the gear stages i_3, i_4 and i_2, the two subtransmissions being coupled to each other by means of the activated shift element K. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. The eighth forward gear G8, starting from the first clutch K1, uses the gear stages i_7, ZW_8 and i_4, the subtransmissions being coupled when coupling device S_ab1 is disengaged. In addition, the reverse gear R1, starting from the second clutch K2, uses the gear stages i_4, i_R and i_5, the subtransmissions being coupled when coupling device S_ab2 is disengaged.

The crawler gear C1, starting from the second clutch K2, uses the gear stages i_2, i_7 and i_5, the two subtransmissions being coupled with each other when shift element I is activated. The crawler gear C2, starting from the second clutch K2, uses the gear stages i_2, i_7 and i_3, the two subtransmissions being coupled to each other when shift element I is activated. The crawler gear C3, starting from the second clutch K2, uses the gear stages i_2, i_5 and i_3, the two subtransmissions being coupled to each other when coupling device S_ab1 is disengaged. The crawler gear C4, starting from the first clutch K1, uses the gear stages i_3, i_6 and i_2, the two subtransmissions being coupled to each other when coupling device S_ab2 is disengaged. The crawler gear C5, starting from the second clutch K2, uses the gear stages i_2, i_7 and i_3, the two subtransmissions being coupled to each other when coupling device S_ab1 is disengaged.

The overdrive gear O1, starting from the second clutch K2, uses the gear stages i_4, i_3 and i_7, the two subtransmissions being coupled to each other when shift element K is activated. In addition, the overdrive gear O2, starting from the second clutch K2, uses the gear stages i_6, i_3 and i_7, the two subtransmissions being coupled to each other when coupling device S_ab2 is disengaged. In addition, the overdrive gear O3, starting from the second clutch K2, uses the gear stages i_6, i_3 and i_5, the subtransmissions being coupled to each other when coupling device S_ab2 is disengaged. The overdrive gear O4, starting from the first clutch K1, uses the gear stages i_7, i_2 and 1_6, the subtransmissions being coupled with each other when shift element I is activated. The overdrive gear O5, starting from the first clutch K1, uses the gear stages i_7, i_2 and i_4, the subtransmissions being coupled to each other when shift element I is activated. The overdrive gear O6, starting from the first clutch K1, uses the gear stages i_5, i_2 and i_6, the subtransmissions being coupled to each other when coupling device S_ab1 is disengaged. The overdrive gear O7, starting from the first clutch K1, uses the gear stages i_7, i_2 and i_6, the subtransmissions being coupled to each other when coupling device S_ab1 is disengaged. The overdrive gear O8, starting from the first clutch K1, uses the gear stages i_7, i_2 and i_4, the subtransmissions being coupled to each other when coupling device S_ab1 is disengaged.

The shift pattern according to FIG. 14 shows in detail that the first forward gear C1, starting from the first clutch K1, uses the gear stages i_3, i_4 and i_2, the two subtransmissions being coupled to each other by means of the activated shift element K. The second forward gear G2 uses gear stage i_2, the third forward gear G3 uses gear stage i_3, the fourth forward gear G4 uses gear stage i_4, the fifth forward gear G5 uses gear stage i_5, the sixth forward gear G6 uses gear stage i_6 and the seventh forward gear G7 uses gear stage i_7. The eighth forward gear G8, starting from the second clutch K2, uses the gear stages i_2, ZW_8 and i_7, the two subtransmissions being coupled to each other when coupling device S_ab2 is disengaged. In addition, the reverse gear R1, starting from the first clutch K1, uses the gear stages i_7, i_R and i_2, the subtransmissions being coupled when shift element I is activated. The next reverse gear R2, starting from the first clutch K1, uses the gear stages i_5, i_R and i_2, the subtransmissions being coupled when coupling device S_ab1 is disengaged. The reverse gear R3, starting from the first clutch K1, uses the gear stages i_5, i_R and i_4, the subtransmissions being coupled when coupling device S_ab1 is disengaged. The reverse gear R4, starting from the first clutch K1, uses the gear stages i_7, i_R and i_2, the subtransmissions being coupled when coupling device S_ab1 is disengaged.

The overdrive gear O1, starting from the second clutch K2, uses the gear stages i_4, i_3 and i_7, the two subtransmissions being coupled to each other when shift element K is activated.

In summary, the result for the 1st, 2nd and 3rd variant embodiments according to FIGS. 1 through 6, with the winding path gear coupling devices S_ab1 and S_ab2, without other winding path gear shift elements, is that three dual gear planes and two single gear planes are provided.

In the 1st variant embodiment, the first forward gear G1 and the eighth forward gear G8 can be designed as winding path gears. In addition, a reverse gear R2 that is power shiftable to the second forward gear is provided, thereby enabling rocking free when stuck. Furthermore, an additional overdrive gear O3 that is power shiftable to the seventh forward gear is realizable as an alternative power shiftable eighth forward gear, to save fuel.

In detailed terms, the result for the 1st variant embodiment is that in the first gear plane 8-12, as a dual gear plane, idler gear 8 is used for three forward gears, R1, R2, R3, and idler gear 12 for three forward gears G1, G2, C2 and for one reverse gear R2. In the second gear plane 9-2, as a single gear plane, idler gear 9 is used for five forward gears G1, G4, C1, O2, O4. In the third gear plane 3-13, as a single gear plane, idler gear 13 is used for six forward gears G6, G8, O1, O2, O3, O4 and for one reverse gear R3. In the fourth gear plane 10-14, as a dual gear plane, idler gear 10 is used for six forward gears G7, C1, O1, O2, O3, O4 and for one reverse gear R1, and idler gear 14 for four forward gears G5, C2, O1, O3. In the fifth gear plane 11-15, as a dual gear plane, idler gear 11 is used for five forward gears G1, G3, G8, C1, C2 and for one reverse gear R2, and idler gear 15 for one forward gear G8 and for two reverse gears R1, R3.

In summary, the 2nd variant embodiment according to FIGS. 3 and 4 results in the same advantages as the 1st variant embodiment, but with the additional advantage that that the eighth forward gear can be designed as a power shiftable winding path gear.

In detailed terms, the result for the 2nd variant embodiment is that in the first gear plane 8-12, as a dual gear plane, idler gear 8 is used for three forward gears, R1, R2, R3, and idler gear 12 for four forward gears G1, G2, G8, C2 and for one reverse gear R2. In the second gear plane 9-2, as a single gear plane, idler gear 9 is used for five forward gears G1, G4, O1, O2, O4. In the third gear plane 3-13, as a single gear plane, idler gear 13 is used for five forward gears G6, O1, O2, O3, O4 and for one reverse gear R3. In the fourth gear plane 10-14, as a dual gear plane, idler gear 10 is used for seven forward gears G7, G8, C1, O1, O2, O3, O4 and for one reverse gear R1, and idler gear 14 for four forward gears G5, C2, O1, O3. In the fifth gear plane 11-15, as a dual gear plane, idler gear 11 is used for four forward gears G1, G3, C1, C2 and for one reverse gear R2, and idler gear 15 for one forward gear G8 and for two reverse gears R1, R3.

In the 3rd variant embodiment, the first forward gear is not a winding path gear, but the eighth forward gear can be designed as a power shiftable winding path gear. In addition, two reverse gears R1, R2 that are power shiftable to the first forward gear are realizable, enabling rocking free when stuck. Another result is a crawler gear C1 that is power shiftable to the first forward gear, to enable better off-road driving properties. Finally, two additional overdrive gears O4, O5 that are power shiftable to the seventh forward gear can be made possible as alternative power shiftable eighth forward gears, to save fuel.

In detailed terms, the result for the 3rd variant embodiment is that in the first gear plane 8-12, as a dual gear plane, idler gear 8 is used for four forward gears G1, G8, C2, C3 and for one reverse gear R4, and idler gear 12 for four reverse gears R1, R2, R3, R4. In the second gear plane 9-2, as a single gear plane, idler gear 9 is used for six forward gears G4, C2, O1, O2, O4, O5. In the third gear plane 3-13, as a single gear plane, idler gear 13 is used for five forward gears G6, C1, C3, C4, O3. In the fourth gear plane 10-14, as a dual gear plane, idler gear 10 is used for seven forward gears G1, G8, C1, C2, O1, O2, O5 and for two reverse gears R1, R2, and idler gear 14 for five forward gears G5, C3, C4, O1, O3 and for two reverse gears R1, R4. In the fifth gear plane 11-15, as a dual gear plane, idler gear 11 is used for three forward gears G3, C4, O4 and for one reverse gear R3, and idler gear 15 for seven forward gears G7, G8, C1, O2, O3, O4, O5 and for two reverse gears R2, R3.

In summary, the result for the 4th and 5th variant embodiments according to FIGS. 7-10, with the two winding path gear coupling devices S_ab1 and S_ab2 and with the additional winding path gear shift element I, is that the first and the eighth forward gears are shiftable as winding path gears.

In the 4th variant embodiment according to FIGS. 7 and 8, two dual gear planes and three single gear planes are provided. Furthermore, two additional overdrive gears O1, O5 that are power shiftable to the seventh forward gear are realizable as alternative power shiftable eighth forward gears, to save fuel.

In detailed terms, the result for the 4th variant embodiment is that in the first gear plane 8-1, as a single gear plane, idler gear 8 is used for five forward gears G1, G2, G8, C1, O3. In the second gear plane 9-2, as a single gear plane, idler gear 9 is used for four forward gears G1, G4, O1, O4. In the third _{g}ear plane 3-13, as a single gear plane, idler gear 13 is used for six forward gears G6, G8, O2, O3, O4, O5 and for one reverse gear R3. In the fourth gear plane 10-14, as a dual gear plane, idler gear 10 is used for four forward gears G1, G3, G8, O1 and for two reverse gears R1, R3, and idler gear 14 for four forward gears G5, C1, O2, O5. In the fifth gear plane 11-15, as a dual gear plane, idler gear 11 is used for seven forward gears G7, C1, O1, O2, O3, O4, O5 and for one reverse gear R2, and idler gear 10 for three reverse gears R1, R2, R3.

In summary, the result for the 5th variant embodiment according to FIGS. 9 and 10, with three dual gear planes and two single gear planes, is a power-shiftable eighth forward gear as a winding path gear. Another result is a reverse gear R3 that is power shiftable to the second forward gear, thereby enabling rocking free when stuck. A further result is two additional overdrive gears O1, O2 that are power shiftable to the seventh forward gear, as alternative power-shiftable eighth forward gears to save fuel.

In detailed terms, the result for the 5th variant embodiment is that in the first gear plane 8-12, as a dual gear plane, idler gear 8 is used for four reverse gears, R1, R2, R3, R4, and idler gear 12 for four forward gears G1, G2, G8, C1 and for one reverse gear R3. In the second gear plane 9-2 idler gear 9 is used for four forward gears G1, G4, O1, O3. In the third gear plane 3-13, as a single gear plane, idler gear 13 is used for three forward gears G6, O2, O3 and for two reverse gears R2, R4. In the fourth gear plane 10-14, as a dual gear plane, idler gear 10 is used for four forward gears G1, G3, C1, O1 and for one reverse gear R3, and idler gear 14 for one forward gear G8 and for three reverse gears R1, R2, R4. In the fifth gear plane 11-15, as a dual gear plane, idler gear 11 is used for five forward gears G7, G8, O1, O2, O3 and for reverse gear R1, and idler gear 15 for three forward gears G5, C1, O2.

In summary, the result for the 6th and 7th variant embodiments, with the two winding path gear coupling devices S_ab1 and S_ab2 and the winding path gear shift element K, is the first forward gear and the eighth forward gear as winding path gears, with three dual gear planes and two single gear planes being provided.

A further result in the 6th variant embodiment is that the eighth forward gear is not power shiftable. In addition, a crawler gear C4 that is power shiftable to the second forward gear may be realized for better off-road driving properties. A further result is two additional overdrive gears O1, O2 that are power shiftable to the seventh forward gear, as alternative power-shiftable eighth forward gears to save fuel.

In detailed terms, the result for the 6th variant embodiment is that in the first gear plane 8-12, as a dual gear plane, idler gear 8 is used for one forward gear G8, and idler gear 12 for seven forward gears G6, C4, O2, O3, O4, O6, O7. In the second gear plane 9-13, as a dual gear plane, idler gear 9 is used for 12 forward gears G1, G2, C1, C2, C3, C4, C5, O4, O5, O6, O7, O8, and idler gear 13 for six forward gears G1, G4, G8, O1, O5, O8 and for one reverse gear R1. In the third gear plane 10-3, as a single gear plane, idler gear 10 is used for 11 forward gears G7, G8, C1, C2, C5, O1, O2, O4, O5, O7, O8. In the fourth gear plane 4-14, as a single gear plane, idler gear 14 is used for nine forward gears G1, G3, C2, C3, C4, C5, O1, O2, O3. In the fifth gear plane 11-15, as a dual gear plane, idler gear 11 is used for five forward gears G5, C1, C3, O3, O6 and for one reverse gear, and idler gear 15 for one reverse gear R1.

A further result in the 7th variant embodiment is that the eighth forward gear can be designed to be power shiftable. Another result is two reverse gears R2, R4 that are power shiftable to the second forward gear, thereby enabling rocking free when stuck. Furthermore, an additional overdrive gear O1 that is power shiftable to the seventh forward gear can be realized as an alternative power-shiftable eighth forward gear, to save fuel.

In detailed terms, the result for the 7th variant embodiment is that in the first gear plane 8-12, as a dual gear plane, idler gear 8 is used for one forward gear G6, and idler gear 12 for three forward gears G1, G2, G8 and for three reverse gears R1, R2, R4. In the second gear plane 9-13, as a dual gear plane, idler gear 9 is used for four reverse gears R1, R2, R3, R4, and idler gear 13 for four forward gears G1, G4, O1 and for one reverse gear R3. In the third gear plane 10-3, as a single gear plane, idler gear 10 is used for three forward gears G7, G8, O1 and for two reverse gears R1, R4. In the fourth gear plane 4-14, as a single gear plane, idler gear 14 is used for three forward gears G1, G3, O1. In the fifth gear plane 11-15, as a dual gear plane, idler gear 11 is used for one forward gear G5 and for two reverse gears R2, R3, and idler gear 15 for one forward gear G8.

It is possible that in one or more variant embodiments at least one additional gear stage ZW_x (e.g., ZW_8) may be utilized for winding path gears that are not used in a direct forward gear. The utilization of an additional gear stage is evident from the figures for the respective variant embodiments.

It is also possible to use gear wheels x1, x2, . . . x7, x8 for additional winding path gears, which may be added to supplement a single gear plane, the gear wheels x1, x2, . . . x7, x8 being numbered as follows. The numbering begins with the first gear wheel x1 of the first countershaft w_v1, starting from the assigned output stage i_ab_1 and continuing sequentially until the fourth gear wheel x4, the first gear wheel on the second countershaft w_v2 starting from the assigned output stage i_ab_2 being designated as x5 and the additional gear wheels being designated continuously up to x8. If the additional gear wheel x1, x2, . . . x7, x8 is used in a reverse gear transmission, a rotation reversal will take place, as for example through the use of an intermediate gear ZR on an intermediate shaft w_zw or the like.

In all variant embodiments of the double clutch transmission, because of these provisions for multiple use of individual idler gears, fewer gear planes are necessary, and thus fewer parts while the number of gears remains the same, so that an advantageous saving of construction space and cost is achieved.

Independent of the particular variant embodiment, the number “1” in a field of the particular table of the shift patterns according to FIGS. 2, 4, 6, 8, 10, 12 and 14 means that the assigned clutch K1, K2 or the assigned coupling device A, B, C, D, E, F, G, H or the assigned shift element I, K is engaged or activated. On the other hand, a blank field in the particular table of the shift patterns according to FIGS. 2, 4, 6, 8, 10, 12 and 14 means that the assigned clutch K1, K2 or the assigned coupling device A, B, C, D, E, F, G, H or the assigned shift element I, K is disengaged.

For the coupling device S_ab1 or S_ab2 assigned to an output gear 17 or 18, deviating from the previously stated rules, when there is a blank field in the respective table of the shift patterns according to FIGS. 2, 4, 6, 8, 10, 12 and 14 the coupling device S_ab1 or S_ab2 must be disengaged, and when there is a field with the number “1” in the respective table of the shift patterns according to FIGS. 2, 4, 6, 8 ,10, 12 and 14 the coupling device S_ab1 or S_ab2 should be engaged. Depending on the gear, the coupling element S_ab1 or S_ab2 must be engaged even in the case of a group of gears where there is a field with the number “1,” whereas in contrast, for a different group of gears where there is a field with the number “1,” the coupling element S_ab1 or S_ab2 may be either disengaged or engaged.

Furthermore, in many cases the possibility exists of inserting additional coupling or shift elements without influencing the flow of force. This can enable gear preselection.

### REFERENCE SYMBOLS

1 fixed gear of the second transmission input shaft
2 fixed gear of the second transmission input shaft
3 fixed gear of the first or second transmission input shaft
4 fixed gear of the first transmission input shaft
5 fixed gear of the first transmission input shaft
8 idler gear of the first countershaft
9 idler gear of the first countershaft
10 idler gear of the first countershaft
11 idler gear of the first countershaft
12 idler gear of the second countershaft
13 idler gear of the second countershaft
14 idler gear of the second countershaft
15 idler gear of the second countershaft
16 fixed gear of the output shaft
17 output gear of the first countershaft
18 output gear of the first countershaft
19 torsion vibration damper
K1 first clutch
K2 second clutch
w_an drive shaft
w_ab output shaft
w_v1 first countershaft
w_v2 second countershaft
w_k1 first transmission input shaft
w_k2 second transmission input shaft
A coupling device
B coupling device
C coupling device
D coupling device
E coupling device
F coupling device
G coupling device
H coupling device
I_1 gear stage of first forward gear
i_2 gear stage of second forward gear
i_3 gear stage of third forward gear
i_4 gear stage of fourth forward gear
i_5 gear stage of fifth forward gear
i_6 gear stage of sixth forward gear
i_7 gear stage of seventh forward gear
ZW_8 additional gear stage for winding path gears
_x5 gear wheel for additional winding path gears
i_ab_1 output stage on the first countershaft
i_ab_2 output stage on the second countershaft
G1 first forward gear
G2 second forward gear
G3 third forward gear
G4 fourth forward gear
G5 fifth forward gear
G6 sixth forward gear
G7 seventh forward gear
G8 eighth forward gear
C1 crawler gear
C2 crawler gear
C3 crawler gear
C4 crawler gear
C5 crawler gear
O1 overdrive gear
O2 overdrive gear
O3 overdrive gear
O4 overdrive gear
O5 overdrive gear
O6 overdrive gear
O7 overdrive gear
O8 overdrive gear
R1 reverse gear
R2 reverse gear
R3 reverse gear
R4 reverse gear
w_zw intermediate shaft
ZR intermediate gear for rotation reversal
ZS utilized gear stage
I shift element
K shift element
S_ab1 coupling device on the output shaft
S_ab2 coupling device on the output shaft
n. lsb. non-power-shiftable
lsb. power shiftable

1-21. (canceled)

22. A double clutch transmission comprising:
first and second clutches (K1, K2) each having an input side connected to a drive shaft (w_an) and an output side connected to one of a first and a second transmission input shaft (w_k1, w_k2) coaxially arranged with respect to one another;
at least first and second countershafts (w_v1, w_v2) upon which toothed idler gearwheels (8, 9, 10, 11, 12, 13, 14, 15) are rotationally supported;
the first and the second transmission input shafts (w_k1, w_k2) supporting fixed gearwheels (1, 2, 3, 4, 5), and the fixed gearwheels (1, 2, 3, 4, 5) meshing with at least one of the idler gearwheels (8, 9, 10, 11, 12, 13, 14, 15);
a plurality of coupling devices (A, B, C, D, E, F, G, H) for coupling an idler gearwheel (8, 9, 10, 11, 12, 13, 14, 15) with one of the first and the second countershafts (w_v1, w_v2) in a rotationally fixed manner;
a first output gear (17) being provided on the first countershaft (w_v1) and a second output gear (18) being provided on the second countershaft (w_v2), and each of the first and the second output gears (17, 18) being coupled to gearing of an output shaft (w_ab) so that at least several power shiftable forward gears (1, 2, 3, 4, 5, 6, 7) and at least one reverse gear (R1, R2, R3, R4) being shiftable;
wherein the double clutch transmission has five gear planes (8-1, 8-12, 9-2, 9-13, 3-13, 10-3, 10-14, 4-14, 11-15) and at least two of the five gear planes are dual gear planes (8-12, 9-13, 10-14, 11-15), each of the dual gear planes (8-12, 9-13, 10-14, 11-15) comprises an idler gearwheel (8, 9, 10, 11, 12, 13, 14, 15) of each of the first and the second countershafts (w_v1, w_v2) and a fixed gear (1, 2, 4, 5) of one of the first and the second transmission input shafts (w_k1, w_k2), at least one idler gearwheel (8, 9, 10, 11, 12, 13, 14, 15) in each of the dual gear planes (8-12, 9-13, 10-14, 11-15) is utilized for at least two gears such that at least one winding path gear is shiftable when upon disengagement of one of a first output coupling device (S_ab1) associated with the first output gear (17) and a second output coupling device (S_ab2) associated with the second output gear (18).

23. The double clutch transmission according to claim 22, wherein upon disengagement of the first coupling device (S_ab1) on the first countershaft (w_v1), at least one of a first forward gear (G1), an eighth forward gear (G8), a reverse gear (R1, R2, R3, R4), a crawler gear (C1, C3, C5) and an overdrive gear (O3, O4, O5, O6, O7, O8) is shiftable as a winding path gear.

24. The double clutch transmission according to claim 22, wherein upon disengagement of the second output coupling device (S_ab2) on the second countershaft (w_v2), at least one of an eighth forward gear (G8), a reverse gear (R1, R2, R3, R4), a crawler gear (C1, C2, C4) and an overdrive gear (O2, O3, O5) is shiftable as a winding path gear.

25. The double clutch transmission according to claim 22, wherein the first countershaft (w_v1) supports at least one shift element (I), and upon activation of the at least one shift element (I) on the first countershaft (w_v1), an idler gear (9) of a second sub-transmission is connectable to an idler gear (10) of a first sub-transmission so that at least one of a first forward gear (G1), a reverse gear (R1), a crawler gear (C1, C2) and an overdrive gear (O1, O2, O4, O5) is shiftable as a winding path gear.

26. The double clutch transmission according to claim 22, wherein the second countershaft (w_v2) supports at least one shift element (K), and upon activation of the at least one shift element (K) on the second countershaft (w_v2) an idler gear (13) of a second sub-transmission is connectable to an idler gear (14) of a first sub-transmission so that at least one of a first forward gear (G1), a reverse gear (R2), a crawler gear (C3) and an overdrive gear (O1, O2, O3) is shiftable as a winding path gear.

27. The double clutch transmission according to claim 22, wherein the double clutch transmission comprises two dual gear planes and three single gear planes, each of a first gear plane (8-1), a second gear plane (9-2) and a third gear plane (3-13) is a single gear plane and comprises a fixed gear (1, 2, 3) of the second transmission input shaft (w_k2) of a second sub-transmission, and a fourth gear plane (10-14) and a fifth gear plane (11-15) are dual gear planes and each comprise a fixed gear (4, 5) of the first transmission input shaft (w_k1) of a first sub-transmission.

28. The double clutch transmission according to claim 22, wherein the double clutch transmission comprises three dual gear planes and two single gear planes, a first gear plane (8-12) is a dual gear plane, a second gear plane (9-2) is a single gear plane, and a third gear plane (3-13) is a single gear plane, each of the first, the second and the third gear planes comprise a fixed gear (1, 2, 3) of the second transmission input shaft (w_k2) of a second sub-transmission, and a fourth gear plane (10-14) is a dual gear plane, and a fifth gear plane (11-15) is a dual gear plane, and each of the fourth and the fifth gear planes comprise a fixed gear (4, 5) of the first transmission input shaft (w_k1) of a first sub-transmission.

29. The double clutch transmission according to claim 22, wherein the double clutch transmission comprises three dual gear planes and two single gear planes, a first gear plane (8-12) and a second gear plane (9-13) are both dual gear planes and comprises a fixed gear (1, 2) of the second transmission input shaft (w_k2) of a second sub-transmission, and a third gear plane (10-3) and a fourth gear plane (4-14) are each a single gear plane, and a fifth gear plane (11-15) is a dual gear plane, and the third, the fourth, the fifth gear planes each comprise a fixed gears (3, 4, 5) of the first transmission input shaft (w_k1) of a first sub-transmission.

30. The double clutch transmission according to claim 22, wherein
a first forward gear (G1) is shiftable as a winding path fear via activation of activation of the first clutch (K1), a second coupling device (B), a fourth coupling device (D) and a fifth coupling device (E) and disengagement of the first output coupling device (S_ab1);
a second forward gear (G2) is shiftable via activation of the second clutch (K2) and the fifth coupling device (E);
a third forward gear (G3) is shiftable via activation of the first clutch (K1) and the fourth coupling device (D);
a fourth forward gear (G4) is shiftable via activation of the second clutch (K2) and the second coupling device (B);
a fifth forward gear (G5) is shiftable via activation of the first clutch (K1) and a seventh coupling device (G);
a sixth forward gear (G6) is shiftable via activation of the second clutch (K2) and a sixth coupling device (F);
a seventh forward gear (G7) is shiftable via activation of the first clutch (K1) and a third coupling device (C);
an eighth forward gear (G8) is shiftable as a winding path gear via activation of the second clutch (K2), the fourth coupling device (D), the sixth coupling device (F) and the eighth coupling device (H) and by disengagement of the second output coupling device (S_ab2);
a first reverse gear (R1) is shiftable as a winding path gear via activation of the second clutch (K2), a first coupling device (A), the third coupling device (C) and an eighth coupling device (H) and by disengagement of first output coupling device (S_ab1);
a second reverse gear (R2) is shiftable as a winding path gear via activation of the first clutch (K1), the first coupling device (A), the fourth coupling device (D) and the fifth coupling device (E) and by disengagement of the first output coupling device (S_ab1); and
a third reverse gear (R3) is shiftable as a winding path gear via activation of the first clutch (K1), the first coupling device (A), the sixth coupling device (F) and the eighth coupling device (H) and by disengagement of the second output coupling device (S_ab2).

31. The double clutch transmission according to claim 22, wherein
a first forward gear (G1) is shiftable as a winding path gear via activation of the first clutch (K1), a second coupling device (B), a fourth coupling device (D) and a fifth coupling device (E) and by disengagement of the first output coupling device (S_ab1);
a second forward gear (G2) is shiftable via activation of the second clutch (K2) and the fifth coupling device (E);
a third forward gear (G3) is shiftable via activation of the first clutch (K1) and the fourth coupling device (D);
a fourth forward gear (G4) is shiftable via activation of the second clutch (K2) and the second coupling device (B);
a fifth forward gear (G5) is shiftable via activation of the first clutch (K1) and a seventh coupling device (G);
a sixth forward gear (G6) is shiftable via activation of the second clutch (K2) and a sixth coupling device (F);
a seventh forward gear (G7) is shiftable via activation of the first clutch (K1) and a third coupling device (C);
an eighth forward gear (G8) is shiftable as a winding path gear via activation of the second clutch (K2), the third coupling device (C), the fifth coupling device (E) and an eighth coupling device (H) and by disengagement of the second output coupling device (S_ab2);
a first reverse gear (R1) is shiftable as a winding path gear via activation of the second clutch (K2), a first coupling device (A), the third coupling device (C) and the eighth coupling device (H) and by disengagement of the first output coupling device (S_ab1);
a second reverse gear (R2) is shiftable as a winding path gear via activation of the first clutch (K1), the first coupling device (A), the fourth coupling device (D) and the fifth coupling device (E) and by disengagement of the first output coupling device (S_ab1);
a third reverse gear (R3) is shiftable as a winding path gear via activation of the first clutch (K1), the first coupling device (A), the sixth coupling device (F) and the eighth coupling device (H) and by disengagement of the second output coupling device (S_ab2).

32. The double clutch transmission according to claim 30, wherein
a first crawler gear (C1) is shiftable as a winding path gear via activation of the second clutch (K2), the fourth coupling device (D) and a first shift element (I);
a crawler gear (C2) is shiftable as a winding path gear via activation of the second clutch (K2), the fourth coupling device (D), the fifth coupling device (E) and the seventh coupling device (G) and by disengagement of the second output coupling device (S_ab2);
a first overdrive gear (O1) is shiftable as a winding path gear via activation of the second clutch (K2), the third coupling device (C) and a second shift element (K);
a second overdrive gear (O2) is shiftable as a winding path gear via activation of the first clutch (K1), the sixth coupling device (F) and the first shift element (I);
a third overdrive gear (O3) is shiftable as a winding path gear via activation of the second clutch (K2), the third coupling device (C), the sixth coupling device (F) and the seventh coupling device (G), and by disengagement of the second output coupling device (S_ab2);
a fourth overdrive gear (O4) is shiftable as a winding path gear via activation of the first clutch (K1), the second coupling device (B), the third coupling device (C) and the sixth coupling device (F) and by disengagement of the first output coupling device (S_ab1).

33. The double clutch transmission according to claim 22, wherein
a first forward gear (G1) is shiftable via activation of the first clutch (K1) and a third coupling device (C);
a second forward gear (G2) is shiftable via activation of the second clutch (K2) and a first coupling device (A);
a third forward gear (G3) is shiftable via activation of the first clutch (K1) and a fourth coupling device (D);
a fourth forward gear (G4) is shiftable via activation of the second clutch (K2) and a second coupling device (B);
a fifth forward gear (G5) is shiftable via activation of the first clutch (K1) and a seventh coupling device (G);
a sixth forward gear (G6) is shiftable via activation of the second clutch (K2) and a sixth coupling device (F);
a seventh forward gear (G7) is shiftable via activation of the first clutch (K1) and a eighth coupling device (H);
an eighth forward gear (G8) is shiftable as a winding path gear via activation of the second clutch (K2), the first coupling device (A), the third coupling device (C) and the eighth coupling device (H) and by disengagement of the first output coupling device (S_ab1);
a first reverse gear (R1) is shiftable as a winding path gear via activation of the second clutch (K2), the third coupling device (C), a fifth coupling device (E) and the seventh coupling device (G) and by disengagement of the second output coupling device (S_ab2);
a second reverse gear (R2) is shiftable as a winding path gear via activation of the second clutch (K2), the third coupling device (C), a fifth coupling device (E) and the eighth coupling device (H) and by disengagement of the second output coupling device (S_ab2);
a third reverse gear (R3) is shiftable as a winding path gear via activation of the second clutch (K2), the fourth coupling device (D), the fifth coupling device (E) and the eighth coupling device (H) and by disengagement of the second output coupling device (S_ab2); and
a fourth reverse gear (R4) is shiftable as a winding path gear via activation of the first clutch (K1), first coupling device (A), the fifth coupling device (E) and the seventh coupling device (G) and by disengagement of the second output coupling device (S_ab2).

34. The double clutch transmission according to claim 33, wherein
a first crawler gear (C1) is shiftable as a winding path gear via activation of the second clutch (K2), the third coupling device (C), the sixth coupling device (F) and the eighth coupling device (H) and by disengagement of the second output coupling device (S_ab2);
a second crawler gear (C2) is shiftable as a winding path gear via activation of the first clutch (K1), the first coupling device (A) and a first shift element (I);
a third crawler gear (C3) is shiftable as a winding path gear via activation of the first clutch (K1), the first coupling device (A) and a second shift element (K);
a fourth crawler gear (C4) is shiftable as a winding path gear via activation of the first clutch (K1), the first coupling device (A), the sixth coupling device (F) and the seventh coupling device (G) and by disengagement of the second output coupling device (S_ab2);
a first overdrive gear (O1) is shiftable as a winding path gear via activation of the second clutch (K2), the seventh coupling device (G) and the first shift element (I);
a second overdrive gear (O2) is shiftable as a winding path gear via activation of the second clutch (K2), the eighth coupling device (H) and the first shift element (I);
a third overdrive gear (O3) is shiftable as a winding path gear via activation of the second clutch (K2), the eighth coupling device (H) and the second shift element (K);
a fourth overdrive gear (O4) is shiftable as a winding path gear via activation of the second clutch (K2), the second coupling device (B), the fourth coupling device (D) and the eighth coupling device (H), and by disengagement of the first output coupling device (S_ab1); and
a fifth overdrive gear (O5) is shiftable as a winding path gear via activation of the second clutch (K2), the second coupling device (B), the third coupling device (C) and the eighth coupling device (H) and by disengagement of the first output coupling device (S_ab1).

35. The double clutch transmission according to claim 22, wherein
a first forward gear (G1) is shiftable as a winding path gear via activation of the first clutch (K1), a first coupling device (A) and a first shift element (I);
a second forward gear (G2) is shiftable via activation of the second clutch (K2) and the first coupling device (A);
a third forward gear (G3) is shiftable via activation of the first clutch (K1) and a third coupling device (C);
a fourth forward gear (G4) is shiftable via activation of the second clutch (K2) and a second coupling device (B);
a fifth forward gear (G5) is shiftable via activation of the first clutch (K1) and a seventh coupling device (G);
a sixth forward gear (G6) is shiftable via activation of the second clutch (K2) and a sixth coupling device (F);
a seventh forward gear (G7) is shiftable via activation of the first clutch (K1) and a fourth coupling device (D);
an eighth forward gear (G8) is shiftable as a winding path gear via activation of the first clutch (K1), the first coupling device (A), the third coupling device (C) and the sixth coupling device (F) and by disengagement of the first output coupling device (S_ab1);
a first reverse gear (R1) is shiftable as a winding path gear via activation of the second clutch (K2), the third coupling device (C), a fifth coupling device (E) and an eighth coupling device (H) and by disengagement of the second output coupling device (S_ab2);
a second reverse gear (R2) is shiftable as a winding path gear via activation of the second clutch (K2), the fourth coupling device (D), the fifth coupling device (E) and the eighth coupling device (H) and by disengagement of the second output coupling device (S_ab2); and
a third reverse gear (R3) is shiftable as a winding path gear via activation of the second clutch (K2), the third coupling device (C), the sixth coupling device (F) and the eighth coupling device (H) and by disengagement of the second output coupling device (S_ab2).

36. The double clutch transmission according to claim 35, wherein a crawler gear (C1) is shiftable as a winding path gear via activation of the second clutch (K2), the first coupling device (A), the fourth coupling device (D) and the seventh coupling device (G) and by disengagement of the first output coupling device (S_ab1);
a first overdrive gear (O1) is shiftable as a winding path gear via activation of the second clutch (K2), the fourth coupling device (D) and the first shift element (I);
a second overdrive gear (O2) is shiftable as a winding path gear via activation of the second clutch (K2), the fourth coupling device (D) and a second shift element (K);
a third overdrive gear (O3) is shiftable as a winding path gear via activation of the first clutch (K1), the first coupling device (A), the fourth coupling device (D) and the sixth coupling device (F) and by disengagement of the first output coupling device (S_ab1);
a fourth overdrive gear (O4) is shiftable as a winding path gear via activation of the first clutch (K1), the second coupling device (B), the fourth coupling device (D) and the sixth coupling device (F) and by disengagement of the first output coupling device (S_ab1);
a fifth overdrive gear (O5) is shiftable as a winding path gear via activation of the second clutch (K2), the fourth coupling device (D), the sixth coupling device (F) and the seventh coupling device (G) and by disengagement of the second output coupling device (S_ab2).

37. The double clutch transmission according to claim 22, wherein
a first forward gear (G1) is shiftable as a winding path gear via activation of the first clutch (K1), a fifth coupling device (E) and a first shift element (I);
a second forward gear (G2) is shiftable via activation of the second clutch (K2) and the fifth coupling device (E);
a third forward gear (G3) is shiftable via activation of the first clutch (K1) and a third coupling device (C);
a fourth forward gear (G4) is shiftable via activation of the second clutch (K2) and a second coupling device (B);
a fifth forward gear (G5) is shiftable via activation of the first clutch (K1) and an eighth coupling device (H);
a sixth forward gear (G6) is shiftable via activation of the second clutch (K2) and a sixth coupling device (F);
a seventh forward gear (G7) is shiftable via activation of the first clutch (K1) and a fourth coupling device (D);
an eighth forward gear (G8) is shiftable as a winding path gear via activation of the second clutch (K2), the fourth coupling device (D), the fifth coupling device (E) and the seventh coupling device (G) and by disengagement of the second output coupling device (S_ab2);
a first reverse gear (R1) is shiftable as a winding path gear via activation of the second clutch (K2), a first coupling device (A), the fourth coupling device (D) and the seventh coupling device (G) and by disengagement of the first output coupling device (S_ab1);
a second reverse gear (R2) is shiftable as a winding path gear via activation of the first clutch (K1), the first coupling device (A) and a second shift element (K);
a third reverse gear (R3) is shiftable as a winding path gear via activation of the first clutch (K1), the first coupling device (A), the third coupling device (C) and the fifth coupling device (E) and by disengagement of the first output coupling device (S_ab1); and
a fourth reverse gear (R4) is shiftable as a winding path gear via activation of the first clutch (K1), the first coupling device (A), the sixth coupling device (F) and the seventh coupling device (G) and by disengagement of the second output coupling device (S_ab2).

38. The double clutch transmission according to claim 37, wherein
a crawler gear (C1) is shiftable as a winding path gear via activation of the second clutch (K2), the third coupling device (C), the fifth coupling device (E) and the eighth coupling device (H) and by disengagement of the second output coupling device (S_ab2);
a first overdrive gear (O1) is shiftable as a winding path gear via activation of the second clutch (K2), the fourth coupling device (D) and the first shift element (I);
a second overdrive gear (O2) is shiftable as a winding path gear via activation of the second clutch (K2), the fourth coupling device (D), the sixth coupling device (F) and the eighth coupling device (H) and by disengagement of the second output coupling device (S_ab2);
a third overdrive gear (O3) is shiftable as a winding path gear via activation of the first clutch (K1), the second coupling device (B), the fourth coupling device (D) and the sixth coupling device (F) and by disengagement of the first output coupling device (S_ab1).

39. The double clutch transmission according to claim 22, wherein
a first forward gear (G1) is shiftable as a winding path gear via activation of the first clutch (K1), a second coupling device (B) and a second shift element (K);
a second forward gear (G2) is shiftable via activation of the second clutch (K2) and the second coupling device (B);
a third forward gear (G3) is shiftable via activation of the first clutch (K1) and a seventh coupling device (G);
a fourth forward gear (G4) is shiftable via activation of the second clutch (K2) and a sixth coupling device (F);
a fifth forward gear (G5) is shiftable via activation of the first clutch (K1) and a fourth coupling device (D);
a sixth forward gear (G6) is shiftable via activation of the second clutch (K2) and a fifth coupling device (E);
a seventh forward gear (G7) is shiftable via activation of the first clutch (K1) and a third coupling device (C);
an eighth forward gear (G8) is shiftable as a winding path gear via activation of the first clutch (K1), a first coupling device (A), the third coupling device (C) and the sixth coupling device (F) and by disengagement of the first output coupling device (S_ab1);
a first reverse gear (R1) is shiftable as a winding path gear via activation of the second clutch (K2), the fourth coupling device (D), the sixth coupling device (F) and the eighth coupling device (H) and by disengagement of the second output coupling device (S_ab2).

40. The double clutch transmission according to claim 39, wherein
a first crawler gear (C1) is shiftable as a winding path gear via activation of the second clutch (K2), the fourth coupling device (D) and a first shift element (I);
a second crawler gear (C2) is shiftable as a winding path gear via activation of the second clutch (K2), the seventh coupling device (G) and the first shift element (I);
a third crawler gear (C3) is shiftable as a winding path gear via activation of the second clutch (K2), the second coupling device (B), the fourth coupling device (D) and the seventh coupling device (G) and by disengagement of the first output coupling device (S_ab1);
a fourth crawler gear (C4) is shiftable as a winding path gear via activation of the first clutch (K1), the second coupling device (B), the fifth coupling device (E) and the seventh coupling device (G) and by disengagement of the second output coupling device (S_ab2);
a fifth crawler gear (C5) is shiftable as a winding path gear via activation of the second clutch (K2), the second coupling device (B), the third coupling device (C) and the seventh coupling device (G) and by disengagement of the first output coupling device (S_ab1);
a first overdrive gear (O1) is shiftable as a winding path gear via activation of the second clutch (K2), the third coupling device (C) and the second shift element (K);
a second overdrive gear (O2) is shiftable as a winding path gear via activation of the second clutch (K2), the third coupling device (C), the fifth coupling device (E) and the seventh coupling device (G) and by disengagement of the second output coupling device (S_ab2);
a third overdrive gear (O3) is shiftable as a winding path gear via activation of the second clutch (K2), the fourth coupling device (D), the fifth coupling device (E) and the seventh coupling device (G) and by disengagement of the second output coupling device (S_ab2);
a fourth overdrive gear (O4) is shiftable as a winding path gear via activation of the first clutch (K1), the fifth coupling device (E) and the first shift element (I);
a fifth overdrive gear (O5) is shiftable as a winding path gear via activation of the first clutch (K1), the sixth coupling device (F) and the first shift element (I);
a sixth overdrive gear (O6) is shiftable as a winding path gear via activation of the first clutch (K1), the second coupling device (B), the fourth coupling device (D) and the fifth coupling device (E) and by disengagement of the first output coupling device (S_ab1);
a seventh overdrive gear (O7) is shiftable as a winding path gear via activation of the first clutch (K1), the second coupling device (B), the third coupling device (C) and the fifth coupling device (E) and by disengagement of the first output coupling device (S_ab1); and
an eighth overdrive gear (O8) is shiftable as a winding path gear via activation of the first clutch (K1), the second coupling device (B), the third coupling device (C) and the sixth coupling device (F) and by disengagement of the first output coupling device (S_ab1).

41. The double clutch transmission according to claim 22, wherein
a first forward gear (G1) is shiftable as a winding path gear via activation of the first clutch (K1), a fifth coupling device (E) and a second shift element (K);
a second forward gear (G2) is shiftable via activation of the second clutch (K2) and a fifth coupling device (E);
a third forward gear (G3) is shiftable via activation of the first clutch (K1) and a seventh coupling device (G);
a fourth forward gear (G4) is shiftable via activation of the second clutch (K2) and a sixth coupling device (F);
a fifth forward gear (G5) is shiftable via activation of the first clutch (K1) and a fourth coupling device (D);
a sixth forward gear (G6) is shiftable via activation of the second clutch (K2) and a first coupling device (A);
a seventh forward gear (G7) is shiftable via activation of the first clutch (K1) and a third coupling device (C);
an eighth forward gear (G8) is shiftable as a winding path gear via activation of the second clutch (K2), the third coupling device (C), the fifth coupling device (E) and an eighth coupling device (H) and by disengagement of the second output coupling device (S_ab2);
a first reverse gear (R1) is shiftable as a winding path gear via activation of the first clutch (K1), the fifth coupling device (E) and a first shift element (I);
a second reverse gear (R2) is shiftable as a winding path gear via activation of the first clutch (K1), a second coupling device (B), the fourth coupling device (D) and the fifth coupling device (E) and by disengagement of the first output coupling device (S_ab1);
a third reverse gear (R3) is shiftable as a winding path gear via activation of the first clutch (K1), the second coupling device (B), the fourth coupling device (D) and the sixth coupling device (F) and by disengagement of the first output coupling device (S_ab1); and
a fourth reverse gear (R4) is shiftable as a winding path gear via activation of the first clutch (K1), the second coupling device (B), the third coupling device (C) and the fifth coupling device (E) and by disengagement of the first output coupling device (S_ab1).

42. The double clutch transmission according to claim 41, wherein an overdrive gear (O1) is shiftable as a winding path gear via activation of the second clutch (K2), the third coupling device (C) and the second shift element (K).
